(19) United States
(12) Patent Application Publication
(10) Pub. No.: US 2008/0112091 A1
(43) Pub. Date: May 15, 2008

(54) Current-confined-path type magnetoresistive element and method of manufacturing same

(75) Inventors: Koji Shimazawa, Tokyo (JP); Yoshihiro Tsuchiya, Tokyo (JP); Tomohito Mizuno, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/896,707

(22) Filed: Sep. 5, 2007

(30) Foreign Application Priority Data
Nov. 14, 2006 (JP) 2006-307368

(51) Int. Cl. G11B 5/33

(52) U.S. Cl. 360/324.1

(57) ABSTRACT

A spacer layer of an MR element includes: a nonmagnetic metal layer disposed on a pinned layer; a protection layer disposed on the nonmagnetic metal layer to prevent oxidation or nitriding of the nonmagnetic metal layer; an island-shaped insulating layer disposed on the protection layer; and a coating layer covering these layers. When seen in a direction perpendicular to the top surface of the pinned layer, there are formed in the spacer layer a region where the insulating layer is present and a region where the insulating layer is absent. A thickness of the protection layer taken in at least part of the region where the insulating layer is absent is zero or smaller than a thickness of the protection layer taken in the region where the insulating layer is present.

### BACKGROUND OF THE INVENTION

1. Field of the Invention

The present invention relates to a magnetoresistive element in which a current for detecting magnetic signals is fed in a direction intersecting the plane of each layer making up the magnetoresistive element, a method of manufacturing the same, and a thin-film magnetic head, a head gimbal assembly, a head arm assembly and a magnetic disk drive each of which includes the magnetoresistive element.

2. Description of the Related Art

Performance improvements in thin-film magnetic heads have been sought as areal recording density of magnetic disk drives has increased. A widely used type of thin-film magnetic head is a composite thin-film magnetic head that has a structure in which a write head having an induction-type electromagnetic transducer for writing and a read head having a magnetoresistive element (that may be hereinafter referred to as MR element) for reading are stacked on a substrate.

MR elements include GMR (giant magnetoresistive) elements utilizing a giant magnetoresistive effect and TMR (tunneling magnetoresistive) elements utilizing a tunneling magnetoresistive effect.

Read heads are required to have characteristics of high sensitivity and high output. As the read heads that satisfy such requirements, GMR heads that employ spin-valve GMR elements have been mass-produced. Recently, to accommodate further improvements in areal recording density, developments have been pursued for read heads employing TMR elements.

A spin-valve GMR element typically includes a free layer, a pinned layer, a nonmagnetic conductive layer disposed between the free layer and the pinned layer, and an antiferromagnetic layer disposed on a side of the pinned layer farther from the nonmagnetic conductive layer. The free layer is a ferromagnetic layer whose direction of magnetization changes in response to a signal magnetic field. The pinned layer is a ferromagnetic layer whose direction of magnetization is fixed. The antiferromagnetic layer is a layer that fixes the direction of magnetization of the pinned layer by means of exchange coupling with the pinned layer.

Conventional GMR heads have a structure in which a current used for detecting magnetic signals (hereinafter referred to as a sense current) is fed in the direction parallel to the plane of each layer making up the GMR element. Such a structure is called a CIP (current-in-plane) structure. Hereinafter, a GMR element used for read heads having the CIP structure is called a CIP-GMR element.

In a read head having the CIP structure, the CIP-GMR element is disposed between two shield layers made of soft magnetic metal films and disposed on the top and bottom of the CIP-GMR element. A shield gap film made of an insulating film is disposed between the CIP-GMR element and the respective shield layers. In this read head the linear recording density is determined by the distance between the two shield layers (hereinafter called a read gap length).

With an increase in recording density, there have been increasing demands for reductions in read gap length and track width. In a read head, a reduction in track width is achieved by a reduction in width of the MR element. As the width of the MR element is reduced, the length of the MR element taken in a direction perpendicular to the medium facing surface of the thin-film magnetic head is also reduced. As a result, the areas of the bottom and top surfaces of the MR element decrease.

In a read head having the CIP structure, since the CIP-GMR element is isolated from the shield layers by the respective shield gap films, the heat release efficiency decreases if the areas of the bottom and top surfaces of the MR element decrease. Consequently, a read head of this type has a problem that the operating current is limited so as to secure the reliability.

On the other hand, as disclosed in JP 9-288807A, for example, there has also been proposed a GMR head having a structure in which a sense current is fed in a direction intersecting the plane of each layer making up the GMR element, such as the direction perpendicular to the plane of each layer making up the GMR element. Such a structure is called a current-perpendicular-to-plane (CPP) structure. A GMR element used for read heads having the CPP structure is hereinafter called a CPP-GMR element.

A read head having the CPP structure requires no shield gap film, wherein electrode layers touch the bottom and top surfaces of the CPP-GMR element, respectively. The electrode layers may also function as the shield layers. The read head having the CPP structure is capable of solving the foregoing problem of the read head having the CIP structure. That is, the read head having the CPP structure exhibits good heat release efficiency since the electrode layers touch the bottom and top surfaces of the CPP-GMR element, respectively. It is therefore possible to increase the operating current in this read head. Furthermore, in this read head, the smaller the areas of the bottom and top surfaces of the CPP-GMR element, the higher is the resistance of the element and the greater is the magnetoresistance change amount. This read head therefore allows a reduction in track width. Furthermore, this read head allows a reduction in read gap length. Accordingly, the CPP structure is considered to be a technique requisite for achieving an areal recording density higher than 200 gigabits per square inches.

A practical CPP-GMR element is disclosed in Nagasaka et al., “Giant Magnetoresistance Properties of Spin Valve Films in Current-perpendicular-to-plane Geometry”, Journal of the Magnetics Society of Japan, vol. 25, no. 4-2, pp. 807-810 (2001). Here, a description will be made on the film configuration of a sample called S-1 listed on Table 1 of Nagasaka et al., as an example of film configuration of the CPP-GMR element disclosed in this article. The sample S-1 has a single spin-valve type film configuration including a free layer, a nonmagnetic conductive layer, a pinned layer and an antiferromagnetic layer that are stacked in this order on a lower electrode. An upper electrode is disposed on the antiferromagnetic layer. The free layer is formed by stacking a NiFe layer and a CoFeB layer. The nonmagnetic conductive layer is made of Cu. The pinned layer is formed by stacking a CoFeB layer, a Ru layer and a CoFeB layer. The antiferromagnetic layer is made of PdPtMn. According to Table 2 of Nagasaka et al., the magnetoresistance change ratio (hereinafter called MR ratio), which is a ratio of magnetoresistance change with respect to the resistance, of the sample S-1 is approximately 1.16 percent. Considering practical utilization of the read head, this value of MR ratio is insufficient since it is impossible to increase the output of the read head.

Nagasaka at al. also disclose a dual spin-valve type film configuration. This film configuration is capable of attaining a higher MR ratio, compared with the single spin-valve type film configuration. However, the dual spin-valve type film configuration has a problem that the read gap length is greater.

A CPP-GMR element has an advantage that it has a lower resistance and therefore exhibits a better high frequency response, compared with a TMR element. Furthermore, a CPP-GMR element has an advantage that it is capable of obtaining a higher output when the track width is reduced, compared with a CIP-GMR element. On the other hand, a CPP-GMR element has a disadvantage that since it has a low resistance, its resistance change amount is small. Accordingly, to obtain a high read output with a CPP-GMR element, it is necessary to increase the voltage applied to the element. If the voltage applied to the element is increased, however, the following problem arises. In a CPP-GMR element, a current is fed in the direction perpendicular to the plane of each layer. This causes spin-polarized electrons to be injected from the free layer into the pinned layer or from the pinned layer into the free layer. These spin-polarized electrons generate a torque in the free layer or the pinned layer to rotate the magnetization thereof. In this application this torque is referred to as a spin torque. The spin torque is proportional to the current density. An increase in the voltage applied to the CPP-GMR element causes an increase in current density, thereby resulting in an increase in spin torque. An increase in spin torque results in a problem that the direction of magnetization of the pinned layer is changed.

To cope with this problem, for example, as disclosed in Sahashi et al., “High MR Performance of Spin-valve Films in CPP Geometry”, Journal of the Magnetic Society of Japan, vol. 26, no. 9, pp. 979-984 (2002), there has been proposed a current-confined-path type CPP-GMR element that is capable of having a higher resistance and a greater resistance change amount as compared with a typical CPP-GMR element. This current-confined-path type CPP-GMR element incorporates, instead of the nonmagnetic conductive layer of a typical CPP-GMR element, a spacer layer that includes an insulating portion and a conducting portion such that the insulating portion and the conducting portion are both present in a cross section parallel to the plane of the spacer layer. In this current-confined-path type CPP-GMR element, a current flows locally through the conducting portion in the spacer layer, so that a higher resistance and a greater resistance change amount are obtained as compared with a typical CPP-GMR element.

Sahashi et al. discloses that an MR ratio of approximately 3 percent was obtained for a current-confined-path type CPP-GMR element having a single spin-valve structure. However, such a level of MR ratio is still insufficient in terms of the output of a read head.

JP 2003-204094β discloses a current-confined-path type CPP-GMR element incorporating a spacer layer that includes a pair of conductive layers and an insulating material that is distributed along the interface between the pair of conductive layers. As a process of forming the insulating material, this publication discloses forming the insulating material by oxidizing a magnetic metal material deposited on the surface of the lower one of the conductive layers.

JP 2003-298143A discloses a current-confined-path type CPP-GMR element incorporating a spacer layer that includes a pair of interface adjusting intermediate layers and an oxide intermediate layer that has a current-confining effect and is disposed between the pair of interface adjusting intermediate layers. This publication discloses forming the oxide intermediate layer by oxidizing a metal layer.

JP 2004-327880A discloses a current-confined-path type CPP-GMR element incorporating a spacer layer that includes a pair of nonmagnetic conductive layers, an insulating layer that includes a columnar metal embedded therein and that is disposed between the pair of nonmagnetic conductive layers, and an underlying layer disposed between the insulating layer and the lower one of the nonmagnetic conductive layers. This publication discloses a process of forming the insulating layer with the columnar metal embedded therein by performing sputtering under such a condition that the columnar metal grows in the insulating layer. The underlying layer is provided for epitaxial growth of the columnar metal.

JP 2004-214234A discloses a current-confined-path type CPP-GMR element incorporating a spacer layer made up of a second interface metal layer, a second nonmetal intermediate layer, a metal intermediate layer, a first nonmetal intermediate layer, and a first interface metal layer that are stacked in this order on the pinned layer. Each of the first and the second nonmetal intermediate layer has a conducting phase and an insulating phase that are columnar in shape. This publication discloses a process of forming the first and the second nonmetal intermediate layer by oxidizing an alloy such as AlCu. In addition, this publication discloses that the second interface metal layer has an effect of preventing oxidation of the pinned layer that can occur when an oxidation treatment is performed for forming the second nonmetal intermediate layer.

JP 2003-008108A discloses a technique of providing a current limiting layer on at least one of the top surface and the bottom surface of the free layer of a CPP-GMR element directly or with another layer disposed in between. The current limiting layer is a layer in which an insulating portion and a conducting portion are both present. Furthermore, this publication discloses a technique of providing a precious metal material layer on at least one of the top surface and the bottom surface of the current limiting layer. As one of methods of forming the insulating portion of the current limiting layer, this publication discloses forming a film of metallic element into an island-like shape and then subjecting this film to oxidation to make an insulating material film to become the insulating portion. This publication further discloses that, when the film of metallic element is subjected to oxidation to make the insulating material film, providing an underlying layer made of precious metal (the precious metal material layer) below the current limiting layer allows a film disposed below the underlying layer to be prevented from undergoing oxidation.

JP 2006-054257A discloses a current-confined-path type CPP-GMR element incorporating a spacer layer that includes an insulating layer and current paths penetrating the insulating layer. This publication discloses a process of forming the spacer layer through: depositing a second metal layer on a first metal layer; performing a pretreatment of irradiating the second metal layer with an ion beam or RF plasma of a rare gas; and converting the second metal layer into the insulating layer by supplying an oxidation gas or a nitriding gas.

JP 2005-505932A discloses a technique of providing a dielectric layer or a semiconductor layer with a plurality of conducting bridges passing through the thickness of the dielectric layer or the semiconductor layer in a pinned layer or a free layer or between the pinned layer and the free layer in a CPP-GMR element. As a method for forming the dielectric layer or the semiconductor layer, this publication discloses the following four methods.

In a first method, first, a first conducting material having a low wettability with respect to a base is deposited on the base so as to form a plurality of drops. Next, a second conducting material that is not miscible with the drops is deposited on the drops so as to fill the spaces between the drops with this material. Next, a treatment such as oxidation is performed on the second conducting material located between the drops to thereby form the dielectric layer or the semiconductor layer.

In a second method, first, a layer of a second conducting material is formed on the base. Next, on this layer, a first conducting material having a low wettability with respect to this layer is deposited so as to form a plurality of drops. Next, a treatment such as oxidation is performed on the second conducting material located between the drops to thereby form the dielectric layer or the semiconductor layer.

In a third method, first, a first conducting material having a low wettability with respect to a base and a second conducting material that is not miscible with the first conducting material are deposited at the same time on the base. Next, a treatment such as oxidation is performed on the second conducting material to thereby form the dielectric layer or the semiconductor layer.

In a fourth method, first, a first conducting material having a low wettability with respect to a base is deposited on the base so as to form a plurality of drops. Next, a treatment such as oxidation is performed on the surface of the base to thereby form the dielectric layer or the semiconductor layer.

As disclosed in JP 2003-204094A, JP 2003-298143A, JP 2004-214234A, JP 2003-008108A, JP 2006-054257A and JP 2005-505932A, in a conventional current-confined-path type CPP-GMR element, the insulating portion of the spacer layer is typically formed through oxidation treatment. In this case, a magnetic layer located below the spacer layer would also be oxidized by this oxidation treatment, and as a result, the giant magnetoresistive effect (hereinafter referred to as GMR effect) of the GMR element may suffer degradation.

According to the technique disclosed in JP 2004-327880A, no oxidation treatment is performed when forming the insulating layer with the columnar metal embedded therein. In the GMR element disclosed in this publication, however, the underlying layer provided for epitaxial growth of the columnar metal can be a factor of degrading the GMR effect.

According to the GMR element disclosed in JP 2004-214234A, the second interface metal layer disposed between the pinned layer and the second nonmetal intermediate layer can prevent oxidation of the pinned layer that can occur when an oxidation treatment is performed for forming the second nonmetal intermediate layer. However, a material that has a function of preventing oxidation of a magnetic layer typically has a function of inhibiting the GMR effect. In the GMR element disclosed in JP 2004-214234A, the second interface metal layer can therefore be a factor of degrading the GMR effect.

According to the GMR element disclosed in JP 2003-008108A, by providing the underlying layer made of precious metal below the current limiting layer, a film disposed below the underlying layer can be prevented from undergoing oxidation. In this GMR element, however, the underlying layer can also be a factor of degrading the GMR effect, as is the case with the second interface metal layer of JP 2004-214234A.

### OBJECT AND SUMMARY OF THE INVENTION

It is an object of the present invention to provide a magnetoresistive element in which the spacer layer includes an insulating portion and a conducting portion such that the insulating portion and the conducting portion are both present in a cross section parallel to the plane of the spacer layer and in which a current for detecting magnetic signals is fed in a direction intersecting the plane of each layer making up the magnetoresistive element, the magnetoresistive element being capable of preventing degradation of the magnetoresistive effect resulting from the formation of the insulating portion, and a method of manufacturing such a magnetoresistive element, and to provide a thin-film magnetic head, a head gimbal assembly, a head arm assembly and a magnetic disk drive each of which includes the magnetoresistive element.

A magnetoresistive element of the present invention includes a first magnetic layer, a second magnetic layer, and a spacer layer disposed between the first magnetic layer and the second magnetic layer. One of the first magnetic layer and the second magnetic layer is a layer whose direction of magnetization is fixed, while the other of the first magnetic layer and the second magnetic layer is a layer whose direction of magnetization changes in response to an external magnetic field. The spacer layer includes an insulating portion and a conducting portion such that the insulating portion and the conducting portion are both present in a cross section parallel to the plane of the spacer layer. In this magnetoresistive element, a current for detecting magnetic signals is fed in a direction intersecting the plane of each layer making up the magnetoresistive element.

The spacer layer includes: a nonmagnetic metal layer made of a nonmagnetic metal material and disposed on the first magnetic layer; a protection layer disposed on the nonmagnetic metal layer to prevent oxidation or nitriding of the nonmagnetic metal layer; and an insulating layer disposed on the protection layer and constituting the insulating portion. When seen in the direction perpendicular to the top surface of the first magnetic layer, there are formed in the spacer layer a region where the insulating layer is present and a region where the insulating layer is absent, and the conducting portion is located in the region where the insulating layer is absent. A thickness of the protection layer taken in at least part of the region where the insulating layer is absent is zero or smaller than a thickness of the protection layer taken in the region where the insulating layer is present.

According to the magnetoresistive element of the invention, oxidation or nitriding of the nonmagnetic metal layer due to the formation of the insulating layer is prevented by the protection layer, and consequently, degradation of the magnetoresistive effect due to the formation of the insulating layer is suppressed. Furthermore, according to the magnetoresistive element of the invention, degradation of the magnetoresistive effect attributable to the protection layer is suppressed because the thickness of the protection layer taken in at least part of the region where the insulating layer is absent is zero or smaller than the thickness of the protection layer taken in the region where the insulating layer is present.

In the magnetoresistive element of the invention, the nonmagnetic metal material used to form the nonmagnetic metal layer may be Cu.

In the magnetoresistive element of the invention, the protection layer may be made of a nonmagnetic metal material that is different from the nonmagnetic metal material used to form the nonmagnetic metal layer. In this case, the nonmagnetic metal material used to form the protection layer may be Au. Alternatively, the nonmagnetic metal material used to form the protection layer may be an AuCu alloy having a Cu content of 20 atomic percent or lower.

In the magnetoresistive element of the invention, the insulating layer may be made of an oxide or a nitride of a nonmagnetic metal material. In this case, the insulating layer may be made of an oxide or a nitride of any of Ti, Zr, Hf, Nb and Cr.

In the magnetoresistive element of the invention, the spacer layer may further include a coating layer made of a nonmagnetic metal material, disposed to cover the nonmagnetic metal layer, the protection layer and the insulating layer and constituting the conducting portion. In this case, the nonmagnetic metal material used to form the coating layer may be Cu.

In the magnetoresistive element of the invention, the maximum difference in level between the top surface of the protection layer in the region where the insulating layer is present and the top surface of either the protection layer or the nonmagnetic metal layer in the region where the insulating layer is absent may be within a range of 50 to 125 percent of the thickness of the protection layer taken in the region where the insulating layer is present.

A method of manufacturing the magnetoresistive element of the present invention includes the steps of: forming the first magnetic layer; forming the spacer layer on the first magnetic layer; and forming the second magnetic layer on the spacer layer.

The step of forming the spacer layer includes the steps of: forming a nonmagnetic metal layer made of a nonmagnetic metal material on the first magnetic layer; forming a protection layer for preventing oxidation or nitriding of the nonmagnetic metal layer on the nonmagnetic metal layer; forming an insulating layer constituting the insulating portion on the protection layer; and partially etching the protection layer using the insulating layer as a mask.

In the method of manufacturing the magnetoresistive element of the invention, when seen in the direction perpendicular to the top surface of the first magnetic layer, there are formed in the spacer layer a region where the insulating layer is present and a region where the insulating layer is absent, and the conducting portion is located in the region where the insulating layer is absent. A thickness of the protection layer taken in at least part of the region where the insulating layer is absent is zero or smaller than a thickness of the protection layer taken in the region where the insulating layer is present.

In the method of manufacturing the magnetoresistive element of the invention, the nonmagnetic metal material used to form the nonmagnetic metal layer may be Cu.

In the method of manufacturing the magnetoresistive element of the invention, the protection layer may be made of a nonmagnetic metal material that is different from the nonmagnetic metal material used to form the nonmagnetic metal layer. In this case, the nonmagnetic metal material used to form the protection layer may be Au. Alternatively, the nonmagnetic metal material used to form the protection layer may be an AuCu alloy having a Cu content of 20 atomic percent or lower.

In the method of manufacturing the magnetoresistive element of the invention, the step of forming the insulating layer may include the steps of: forming an island-shaped layer made of a nonmagnetic metal material on the protection layer, the island-shaped layer being intended to become the insulating layer by undergoing oxidation or nitriding; and causing the island-shaped layer to become the insulating layer by subjecting the island-shaped layer to oxidation or nitriding. In this case, the nonmagnetic metal material used to form the island-shaped layer may be any of Ti, Zr, Hf, Nb and Cr.

In the method of manufacturing the magnetoresistive element of the invention, the step of forming the spacer layer may further include the step of forming a coating layer to cover the nonmagnetic metal layer, the protection layer and the insulating layer, the coating layer being made of a nonmagnetic metal material and constituting the conducting portion. In this case, the nonmagnetic metal material used to form the coating layer may be Cu.

In the method of manufacturing the magnetoresistive element of the invention, in the step of partially etching the protection layer, a portion of the protection layer or a portion of each of the protection layer and the nonmagnetic metal layer may be etched such that the maximum difference in level between the top surface of the protection layer in the region where the insulating layer is present and the top surface of either the protection layer or the nonmagnetic metal layer in the region where the insulating layer is absent falls within a range of 50 to 125 percent of the thickness of the protection layer taken in the region where the insulating layer is present.

In the method of manufacturing the magnetoresistive element of the invention, when the nonmagnetic metal material used to form the nonmagnetic metal layer is Cu and the material used to form the protection layer is Au, the step of forming the protection layer is preferably performed at a temperature of 150° C. or lower.

A thin-film magnetic head of the present invention includes: a medium facing surface that faces toward a recording medium; the magnetoresistive element of the invention disposed near the medium facing surface to detect a signal magnetic field sent from the recording medium; and a pair of electrodes for feeding a current for detecting magnetic signals to the magnetoresistive element.

A head gimbal assembly of the present invention includes: a slider including the thin-film magnetic head of the invention and disposed to face toward a recording medium; and a suspension flexibly supporting the slider. A head arm assembly of the present invention includes: a slider including the thin-film magnetic head of the invention and disposed to face toward a recording medium; a suspension flexibly supporting the slider; and an arm for making the slider travel across tracks of the recording medium, the suspension being attached to the arm.

A magnetic disk drive of the present invention includes: a slider including the thin-film magnetic head of the invention and disposed to face toward a recording medium that is driven to rotate; and an alignment device supporting the slider and aligning the slider with respect to the recording medium.

According to the magnetoresistive element of the invention, oxidation or nitriding of the nonmagnetic metal layer due to the formation of the insulating layer is prevented by the protection layer, and consequently, degradation of the magnetoresistive effect due to the formation of the insulating layer is suppressed. Furthermore, according to the magnetoresistive element of the invention, degradation of the magnetoresistive effect attributable to the protection layer is suppressed because the thickness of the protection layer taken in at least part of the region where the insulating layer is absent is zero or smaller than the thickness of the protection layer taken in the region where the insulating layer is present. As a result, according to the magnetoresistive element or the method of manufacturing the same, or the thin-film magnetic head, the head gimbal assembly, the head arm assembly or the magnetic disk drive including this magnetoresistive element, it is possible to suppress degradation of the magnetoresistive effect of the magnetoresistive element resulting from the formation of the insulating portion of the spacer layer of the magnetoresistive element.

Other and further objects, features and advantages of the invention will appear more fully from the following description.

### BRIEF DESCRIPTION OF THE DRAWINGS

FIG. 1 is a cross-sectional view illustrating a cross section of a read head of a first embodiment of the invention parallel to the medium facing surface.

FIG. 2 is a cross-sectional view illustrating a cross section of the read head of the first embodiment of the invention perpendicular to the medium facing surface and the substrate.

FIG. 3 is a cross-sectional view illustrating a cross section of a thin-film magnetic head of the first embodiment of the invention perpendicular to the medium facing surface and the substrate.

FIG. 4 is a cross-sectional view illustrating a cross section of a pole portion of the thin-film magnetic head of the first embodiment of the invention parallel to the medium facing surface.

FIG. 5 is a perspective view of a slider incorporated in a head gimbal assembly of the first embodiment of the invention.

FIG. 6 is a perspective view of a head arm assembly of the first embodiment of the invention.

FIG. 7 is a view for illustrating the main part of a magnetic disk drive of the first embodiment of the invention.

FIG. 8 is a top view of the magnetic disk drive of the first embodiment of the invention including the thin-film magnetic head.

FIG. 9 is a cross-sectional view of a stack of layers obtained in a step of a method of forming a spacer layer of the first embodiment of the invention.

FIG. 10 is a cross-sectional view of a stack of layers obtained in a step that follows the step illustrated in FIG. 9.

FIG. 11 is a cross-sectional view of a stack of layers obtained in a step that follows the step illustrated in FIG. 10.

FIG. 12 is a cross-sectional view of a stack of layers obtained in a step that follows the step illustrated in FIG. 11.

FIG. 13 is a cross-sectional view illustrating a cross section of the spacer layer of FIG. 12 parallel to the bottom surface of the spacer layer.

FIG. 14 is a view illustrating a region where the insulating layer is present and a region where the insulating layer is absent in the spacer layer of FIG. 12.

FIG. 15 is a cross-sectional view illustrating another example of the spacer layer of the first embodiment of the invention.

FIG. 16 is a cross-sectional view illustrating still another example of the spacer layer of the first embodiment of the invention.

FIG. 17 is a plot illustrating the results of a first experiment.

FIG. 18 is a plot illustrating the results of a second experiment.

FIG. 19 is a plot illustrating the results of a third experiment.

FIG. 20 is a cross-sectional view illustrating a cross section of a read head of a second embodiment of the invention parallel to the medium facing surface.

### DETAILED DESCRIPTION OF THE PREFERRED EMBODIMENTS

### First Embodiment

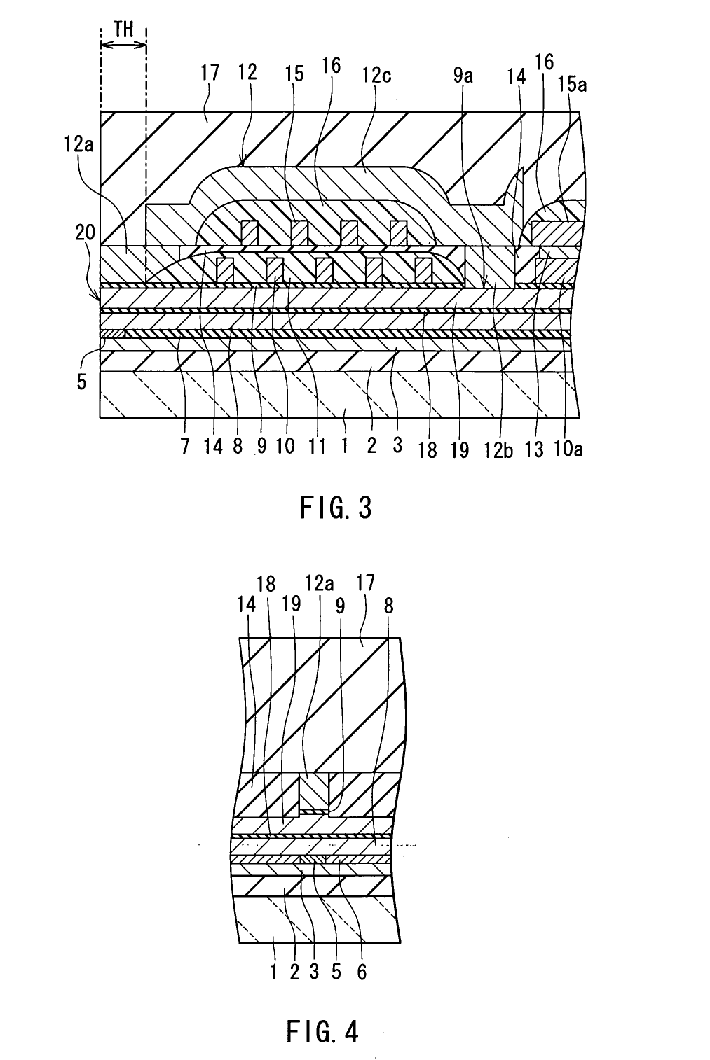

Preferred embodiments of the present invention will now be described in detail with reference to the drawings. Reference is first made to FIG. 3 and FIG. 4 to describe the outline of the configuration of a thin-film magnetic head of a first embodiment of the invention. FIG. 3 is a cross-sectional view illustrating a cross section of the thin-film magnetic head perpendicular to the medium facing surface and the substrate. FIG. 4 is a cross-sectional view illustrating a cross section of a pole portion of the thin-film magnetic head parallel to the medium facing surface.

The thin-film magnetic head of the first embodiment has a medium facing surface 20 that faces toward a recording medium. Furthermore, the thin-film magnetic head includes: a substrate 1 made of a ceramic material such as aluminum oxide and titanium carbide (Al₂O₃—TiC); an insulating layer 2 made of an insulating material such as alumina (Al₂O₃) and disposed on the substrate 1; a first shield layer 3 made of a magnetic material and disposed on the insulating layer 2; an MR element 5 disposed on the first shield layer 3; two bias magnetic field applying layers 6 respectively disposed adjacent to two sides of the MR element 5; and an insulating layer 7 disposed around the MR element 5 and the bias magnetic field applying layers 6. The MR element 5 is disposed near the medium facing surface 20. The insulating layer 7 is made of an insulating material such as alumina.

The thin-film magnetic head further includes: a second shield layer 8 made of a magnetic material and disposed on the MR element 5, the bias magnetic field applying layers 6 and the insulating layer 7; a separating layer 18 made of a nonmagnetic material such as alumina and disposed on the second shield layer 8; and a bottom pole layer 19 made of a magnetic material and disposed on the separating layer 18. The magnetic material used for the second shield layer 8 and the bottom pole layer 19 is a soft magnetic material such as NiFe, CoFe, CoFeNi or FeN. Alternatively, a second shield layer that also functions as a bottom pole layer may be provided in place of the second shield layer 8, the separating layer 18 and the bottom pole layer 19.

The thin-film magnetic head further includes a write gap layer 9 made of a nonmagnetic material such as alumina and disposed on the bottom pole layer 19. The write gap layer 9 has a contact hole 9a formed at a position away from the medium facing surface 20.

The thin-film magnetic head further includes a first layer portion 10 of a thin-film coil disposed on the write gap layer 9. The first layer portion 10 is made of a conductive material such as copper (Cu). In FIG. 3, numeral 10a indicates a connecting portion of the first layer portion 10 connected to a second layer portion 15 of the thin-film coil described later. The first layer portion 10 is wound around the contact hole 9a.

The thin-film magnetic head further includes: an insulating layer 11 made of an insulating material and disposed to cover the first layer portion 10 of the thin-film coil and the write gap layer 9 around the first layer portion 10; a top pole layer 12 made of a magnetic material; and a connecting layer 13 made of a conductive material and disposed on the connecting portion 10a. The connecting layer 13 may be made of a magnetic material. Each of the outer and inner edge portions of the insulating layer 11 has a shape of a rounded sloped surface.

The top pole layer 12 includes a track width defining layer 12a, a coupling portion layer 12b and a yoke portion layer 12c. The track width defining layer 12a is disposed on the write gap layer 9 and the insulating layer 11 over a region extending from a sloped portion of the insulating layer 11 closer to the medium facing surface 20 to the medium facing surface 20. The track width defining layer 12a includes: a front-end portion that is formed on the write gap layer 9 and functions as the pole portion of the top pole layer 12; and a connecting portion that is formed on the sloped portion of the insulating layer 11 closer to the medium facing surface 20 and is connected to the yoke portion layer 12c. The front-end portion has a width equal to the write track width. The connecting portion has a width greater than the width of the front-end portion.

The coupling portion layer 12b is disposed on the bottom pole layer 19 at a position where the contact hole 9a is formed. The yoke portion layer 12c couples the track width defining layer 12a and the coupling portion layer 12b to each other. One of ends of the yoke portion layer 12c that is closer to the medium facing surface 20 is located apart from the medium facing surface 20. The yoke portion layer 12c is connected to the bottom pole layer 19 through the coupling portion layer 12b.

The thin-film magnetic head further includes an insulating layer 14 made of an inorganic insulating material such as alumina and disposed around the coupling portion layer 12b. The track width defining layer 12a, the coupling portion layer 12b, the connecting layer 13 and the insulating layer 14 have flattened top surfaces.

The thin-film magnetic head further includes the second layer portion 15 of the thin-film coil disposed on the insulating layer 14. The second layer portion 15 is made of a conductive material such as copper (Cu). In FIG. 3, numeral 15a indicates a connecting portion of the second layer portion 15 that is connected to the connecting portion 10a of the first layer portion 10 of the thin-film coil through the connecting layer 13. The second layer portion 15 is wound around the coupling portion layer 12b.

The thin-film magnetic head further includes an insulating layer 16 disposed to cover the second layer portion 15 of the thin-film coil and the insulating layer 14 around the second layer portion 15. Each of the outer and inner edge portions of the insulating layer 16 has a shape of rounded sloped surface. Part of the yoke portion layer 12c is disposed on the insulating layer 16.

The thin-film magnetic head further includes an overcoat layer 17 disposed to cover the top pole layer 12. The overcoat layer 17 is made of alumina, for example.

The outline of a manufacturing method of the thin-film magnetic head of the embodiment will now be described. In the manufacturing method of the thin-film magnetic head of the embodiment, first, the insulating layer 2 is formed to have a thickness of 0.2 to 5 μm, for example, on the substrate 1 by a method such as sputtering. Next, on the insulating layer 2, the first shield layer 3 is formed into a predetermined pattern by a method such as plating. Next, although not shown, an insulating layer made of alumina, for example, is formed over the entire surface. Next, the insulating layer is polished by chemical mechanical polishing (hereinafter referred to as CMP), for example, until the first shield layer 3 is exposed, and the top surfaces of the first shield layer 3 and the insulating layer are thereby flattened.

Next, the MR element 5, the two bias magnetic field applying layers 6 and the insulating layer 7 are formed on the first shield layer 3. Next, the second shield layer 8 is formed on the MR element 5, the bias magnetic field applying layers 6 and the insulating layer 7. The second shield layer 8 is formed by plating or sputtering, for example. Next, the separating layer 18 is formed on the second shield layer 8 by a method such as sputtering. Next, the bottom pole layer 19 is formed on the separating layer 18 by plating or sputtering, for example.

Next, the write gap layer 9 is formed to have a thickness of 50 to 300 nm, for example, on the bottom pole layer 19 by a method such as sputtering. Next, in order to make a magnetic path, the contact hole 9a is formed by partially etching the write gap layer 9 at a center portion of the thin-film coil that will be formed later.

Next, the first layer portion 10 of the thin-film coil is formed to have a thickness of 2 to 3 μm, for example, on the write gap layer 9. The first layer portion 10 is wound around the contact hole 9a.

Next, the insulating layer 11 is formed into a predetermined pattern to cover the first layer portion 10 of the thin-film coil and the write gap layer 9 disposed around the first layer portion 10. The insulating layer 11 is made of an organic insulating material that exhibits fluidity when heated, such as photoresist. Next, heat treatment is given at a predetermined temperature to flatten the surface of the insulating layer 11. Through this heat treatment, each of the outer and inner edge portions of the insulating layer 11 is made to have a shape of rounded sloped surface.

Next, the track width defining layer 12a of the top pole layer 12 is formed on the write gap layer 9 and the insulating layer 11 over the region extending from the sloped portion of the insulating layer 11 closer to the medium facing surface 20 described later to the medium facing surface 20.

When the track width defining layer 12a is formed, the coupling portion layer 12b is formed on the bottom pole layer 19 at the position where the contact hole 9a is formed, and the connecting layer 13 is formed on the connecting portion 10a at the same time.

Next, pole trimming is performed. That is, in a region around the track width defining layer 12a, the write gap layer 9 and at least a portion of the pole portion of the bottom pole layer 19 close to the write gap layer 9 are etched using the track width defining layer 12a as a mask. As a result, as shown in FIG. 3, a trim structure is formed, wherein the pole portion of the top pole layer 12, the write gap layer 9 and at least a portion of the pole portion of the bottom pole layer 19 have equal widths. The trim structure makes it possible to prevent an increase in effective track width resulting from an expansion of magnetic flux near the write gap layer 9.

Next, the insulating layer 14 is formed to have a thickness of 3 to 4 μm, for example, over the entire top surface of the stack of layers that has been formed through the foregoing steps. Next, the insulating layer 14 is polished by CMP, for example, to reach the surfaces of the track width defining layer 12a, the coupling portion layer 12b and the connecting layer 13, and is thereby flattened.

Next, the second layer portion 15 of the thin-film coil is formed to have a thickness of 2 to 3 μm, for example, on the insulating layer 14 that has been flattened. The second layer portion 15 is wound around the coupling portion layer 12b.

Next, the insulating layer 16 is formed into a predetermined pattern to cover the second layer portion 15 of the thin-film coil and the insulating layer 14 disposed around the second layer portion 15. The insulating layer 16 is made of an organic insulating material that exhibits fluidity when heated, such as photoresist. Next, heat treatment is given at a predetermined temperature to flatten the surface of the insulating layer 16. Through this heat treatment, each of the outer and inner edge portions of the insulating layer 16 is made to have a shape of rounded sloped surface. Next, the yoke portion layer 12c is formed on the track width defining layer 12a, the insulating layers 14 and 16, and the coupling portion layer 12b.

Next, the overcoat layer 17 is formed to cover the entire top surface of the stack of layers that has been formed through the foregoing steps. Wiring, terminals and so on are then formed on the overcoat layer 17. Finally, machining of the slider including the foregoing layers is performed to form the medium facing surface 20. The thin-film magnetic head including a write head and a read head is thus completed.

The thin-film magnetic head manufactured in this manner has the medium facing surface 20 that faces toward the recording medium, the read head, and the write head. The read head is disposed near the medium facing surface 20 to detect a signal magnetic field sent from the recording medium. The configuration of the read head will be described in detail later.

The write head includes: the bottom pole layer 19 and the top pole layer 12 that are magnetically coupled to each other and include the respective pole portions that are opposed to each other and placed in regions of the pole layers on a side of the medium facing surface 20; the write gap layer 9 provided between the pole portion of the bottom pole layer 19 and the pole portion of the top pole layer 12; and the thin-film coil including the portions 10 and 15 at least part of which is placed between the bottom pole layer 19 and the top pole layer 12 and insulated from the bottom pole layer 19 and the top pole layer 12. In this thin-film magnetic head, as shown in FIG. 2, the length from the medium facing surface 20 to the end of the insulating layer 11 closer to the medium facing surface 20 corresponds to throat height TH. The throat height refers to a length (height) from the medium facing surface 20 to a point at which the distance between the two pole layers starts to increase. It should be noted that, while FIG. 3 and FIG. 4 illustrate a write head for use with the longitudinal magnetic recording system, the write head of the embodiment can be one for use with the perpendicular magnetic recording system.

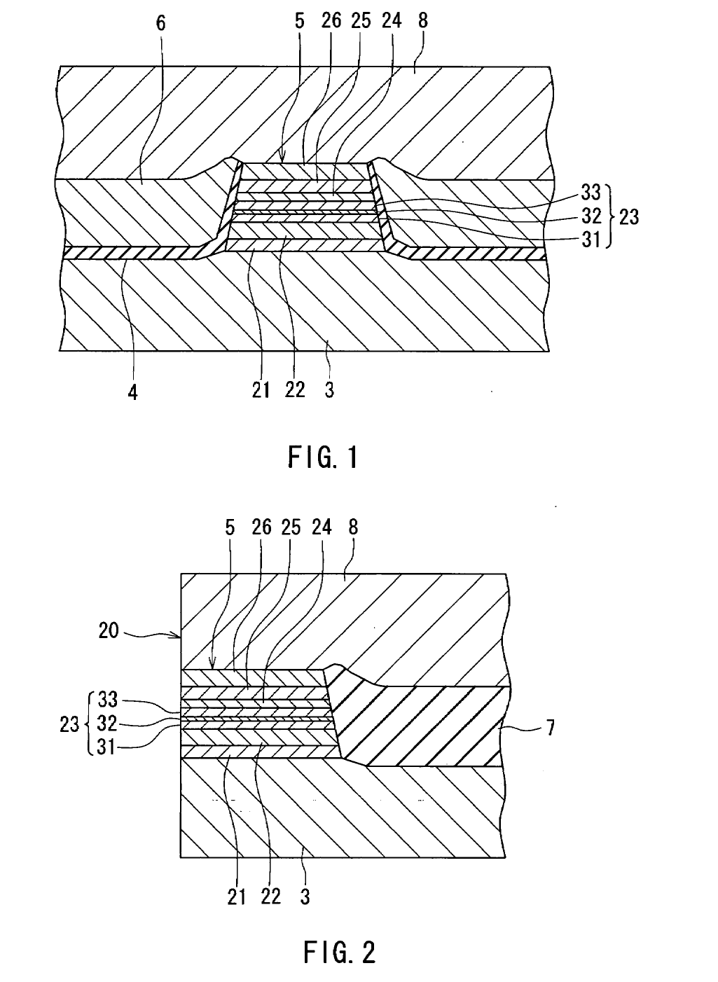

Reference is now made to FIG. 1 and FIG. 2 to describe the configuration of the read head in detail. FIG. 1 is a cross-sectional view illustrating a cross section of the read head parallel to the medium facing surface. FIG. 2 is a cross-sectional view illustrating a cross section of the read head perpendicular to the medium facing surface and the substrate. As shown in FIG. 1 and FIG. 2, the read head includes the first shield layer 3 and the second shield layer 8 disposed at a specific distance from each other, and the MR element 5 disposed between the first shield layer 3 and the second shield layer 8. The MR element 5 and the second shield layer 8 are stacked on the first shield layer 3.

The read head further includes: the two bias magnetic field applying layers 6 that are respectively disposed adjacent to the two sides of the MR element 5 and that apply a bias magnetic field to the MR element 5; and the insulating layer 4 disposed between the first shield layer 3 and the bias magnetic field applying layers 6 and between the MR element 5 and the bias magnetic field applying layers 6.

The bias magnetic field applying layers 6 are formed using a hard magnetic layer (hard magnet) or a stack of a ferromagnetic layer and an antiferromagnetic layer, for example. To be specific, the bias magnetic field applying layers 6 are made of CoPt or CoCrPt, for example. The insulating layer 4 is made of alumina, for example.

The MR element 5 of the embodiment is a current-confined-path type CPP-GMR element. In this MR element 5, a sense current, which is a current used for detecting magnetic signals, is fed in a direction intersecting the plane of each layer making up the MR element 5, such as the direction perpendicular to the plane of each layer making up the MR element 5. The first shield layer 3 and the second shield layer 8 also function as a pair of electrodes for feeding the sense current to the MR element 5 in a direction intersecting the plane of each layer making up the MR element 5, such as the direction perpendicular to the plane of each layer making up the MR element 5. Alternatively, besides the first shield layer 3 and the second shield layer 8, a pair of electrodes may be provided on the top and bottom of the MR element 5, respectively. The MR element 5 has a resistance that changes in response to an external magnetic field, that is, a signal magnetic field from the recording medium. The resistance of the MR element 5 can be determined from the sense current. It is thus possible to read data stored on the recording medium through the use of the read head.

FIG. 1 and FIG. 2 illustrate an example of the configuration of the MR element 5. This MR element 5 includes: a free layer 25 that is a ferromagnetic layer whose direction of magnetization changes in response to the signal magnetic field; a pinned layer 23 that is a ferromagnetic layer whose direction of magnetization is fixed; and a spacer layer 24 disposed between the free layer 25 and the pinned layer 23. According to the present embodiment, the pinned layer 23 is disposed closer to the first shield layer 3 than is the free layer 25. The MR element 5 further includes: an antiferromagnetic layer 22 disposed on a side of the pinned layer 23 farther from the spacer layer 24; an underlying layer 21 disposed between the first shield layer 3 and the antiferromagnetic layer 22; and a protection layer 26 disposed between the free layer 25 and the second shield layer 8. In the MR element 5 illustrated in FIG. 1 and FIG. 2, the underlying layer 21, the antiferromagnetic layer 22, the pinned layer 23, the spacer layer 24, the free layer 25 and the protection layer 26 are stacked in this order on the first shield layer 3. In the embodiment, the pinned layer 23 corresponds to the first magnetic layer of the invention while the free layer 25 corresponds to the second magnetic layer of the invention.

The antiferromagnetic layer 22 is a layer for fixing the direction of magnetization of the pinned layer 23 by means of exchange coupling with the pinned layer 23. The underlying layer 21 is provided for improving the crystallinity and orientability of each layer formed thereon and particularly for enhancing the exchange coupling between the antiferromagnetic layer 22 and the pinned layer 23. The protection layer 26 is a layer for protecting the layers located therebelow.

The underlying layer 21 has a thickness of 2 to 8 nm, for example. The underlying layer 21 is formed of a stack of a Ta layer and a Ru layer, for example.

The antiferromagnetic layer 22 has a thickness of 5 to 30 nm, for example. The antiferromagnetic layer 22 is made of an antiferromagnetic material containing Mn and at least one element M_{II} selected from the group consisting of Pt, Ru, Rh, Pd, Ni, Cu, Ir, Cr and Fe, for example. The Mn content of the material is preferably equal to or higher than 35 atomic percent and lower than or equal to 95 atomic percent, while the content of the other element M_{II} of the material is preferably equal to or higher than 5 atomic percent and lower than or equal to 65 atomic percent. There are two types of the antiferromagnetic material, one is a non-heat-induced antiferromagnetic material that exhibits antiferromagnetism without any heat treatment and induces an exchange coupling magnetic field between a ferromagnetic material and itself, and the other is a heat-induced antiferromagnetic material that exhibits antiferromagnetism by undergoing heat treatment. The antiferromagnetic layer 22 can be made of either of these two types. Examples of the non-heat-induced antiferromagnetic material include a Mn alloy that has a γ phase, such as RuRhMn, FeMn, or IrMn. Examples of the heat-induced antiferromagnetic material include a Mn alloy that has a regular crystal structure, such as PtMn, NiMn, or PtRhMn.

As a layer for fixing the direction of magnetization of the pinned layer 23, a hard magnetic layer made of a hard magnetic material such as CoPt may be provided in place of the antiferromagnetic layer 22 described above. In this case, the material used for the underlying layer 21 is Cr, CrTi or TiW, for example.

In the pinned layer 23, the direction of magnetization is fixed by exchange coupling with the antiferromagnetic layer 22 at the interface between the antiferromagnetic layer 22 and the pinned layer 23. The pinned layer 23 of the embodiment is a so-called synthetic pinned layer, having an outer layer 31, a nonmagnetic middle layer 32 and an inner layer 33 that are stacked in this order on the antiferromagnetic layer 22. Each of the outer layer 31 and the inner layer 33 includes a ferromagnetic layer made of a ferromagnetic material containing at least Co selected from the group consisting of Co and Fe, for example. The outer layer 31 and the inner layer 33 are antiferromagnetic-coupled to each other and the magnetizations thereof are fixed to opposite directions. The outer layer 31 has a thickness of 3 to 7 nm, for example. The inner layer 33 has a thickness of 3 to 10 nm, for example.

The nonmagnetic middle layer 32 has a thickness of 0.35 to 1.0 nm, for example. The nonmagnetic middle layer 32 is made of a nonmagnetic material containing at least one element selected from the group consisting of Ru, Rh, Ir, Re, Cr, Zr and Cu, for example. The nonmagnetic middle layer 32 is provided for producing antiferromagnetic exchange coupling between the inner layer 33 and the outer layer 31, and for fixing the magnetizations of the inner layer 33 and the outer layer 31 to opposite directions. Note that the magnetizations of the inner layer 33 and the outer layer 31 in opposite directions include not only the case in which there is a difference of 180 degrees between these directions of magnetizations, but also the case in which there is a difference of 180±20 degrees between them.

As will be described in detail later, the spacer layer 24 of the embodiment includes an insulating portion and a conducting portion such that the insulating portion and the conducting portion are both present in a cross section parallel to the plane of the spacer layer 24.

The free layer 25 has a thickness of 2 to 10 nm, for example. The free layer 25 is formed of a ferromagnetic layer having a low coercivity. The free layer 25 may include a plurality of ferromagnetic layers stacked.

The protection layer 26 has a thickness of 0.5 to 20 nm, for example. The protection layer 26 may be a Ru layer, for example.

At least one of the inner layer 33 and the free layer 25 may include a Heusler alloy layer.

The operation of the thin-film magnetic head of the embodiment will now be described. The thin-film magnetic head writes data on a recording medium by using the write head and reads data written on the recording medium by using the read head.

In the read head, the direction of the bias magnetic field produced by the bias magnetic field applying layers 6 intersects the direction orthogonal to the medium facing surface 20 at a right angle. In the MR element 5, when no signal magnetic field is present, the direction of magnetization of the free layer 25 is aligned with the direction of the bias magnetic field. On the other hand, the direction of magnetization of the pinned layer 23 is fixed to the direction orthogonal to the medium facing surface 20.

In the MR element 5, the direction of magnetization of the free layer 25 changes in response to a signal magnetic field sent from the recording medium. This causes a change in the relative angle between the direction of magnetization of the free layer 25 and the direction of magnetization of the pinned layer 23, and as a result, the resistance of the MR element 5 changes. The resistance of the MR element 5 can be determined from the potential difference between the first shield layer 3 and the second shield layer 8 produced when a sense current is fed to the MR element 5 from the shield layers 3 and 8. Thus, it is possible for the read head to read data stored on the recording medium.

In the MR element 5 of the embodiment, the spacer layer 24 includes an insulating portion and a conducting portion such that the insulating portion and the conducting portion are both present in a cross section parallel to the plane of the spacer layer 24. Accordingly, in the MR element 5 of the embodiment, the sense current flows locally through the conducting portion in the spacer layer 24. Consequently, as compared with a typical CPP-GMR element in which the spacer layer is made up of a nonmagnetic conductive layer only, the MR element 5 of the embodiment is capable of attaining a greater resistance-area product, a higher resistance and a greater resistance change amount, and is capable of suppressing the effect of spin torque.

A method of manufacturing the MR element 5 of the embodiment will now be described. The method includes the steps of forming the underlying layer 21, the antiferromagnetic layer 22, the pinned layer 23, the spacer layer 24, the free layer 25, and the protection layer 26 in this order on the first shield layer 3. The layers except the spacer layer 24 are formed by sputtering, for example. Here, the step of forming the pinned layer 23 corresponds to the step of forming the first magnetic layer of the invention, while the step of forming the free layer 25 corresponds to the step of forming the second magnetic layer of the invention.

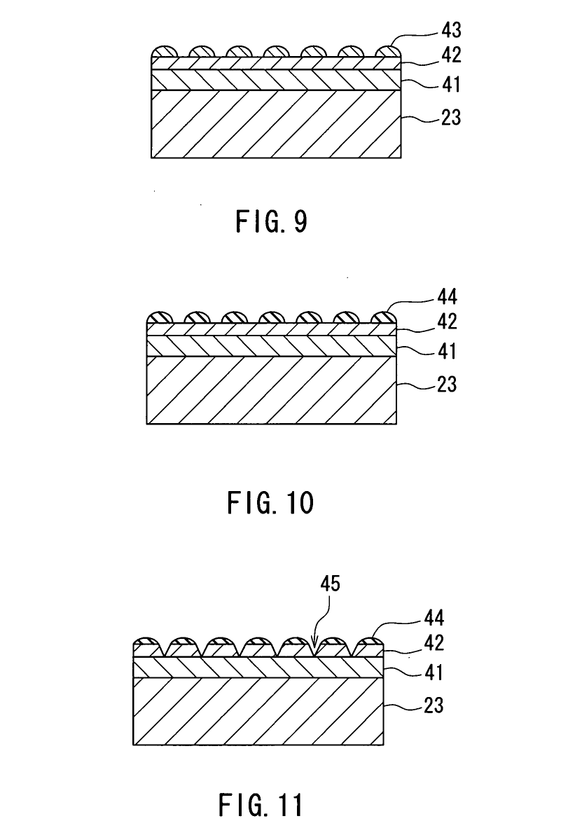

A method of forming the spacer layer 24 of the embodiment will now be described in detail with reference to FIG. 9 to FIG. 12. FIG. 9 to FIG. 12 each illustrate a cross section of a stack of layers obtained in the course of the formation of the spacer layer 24.

In the method of forming the spacer layer 24 of the embodiment, as shown in FIG. 9, a nonmagnetic metal layer 41 made of a nonmagnetic metal material is first formed on the pinned layer 23. For example, the nonmagnetic metal material used to form the nonmagnetic metal layer 41 can be one of Cu and Ag, of which Cu is preferred. The nonmagnetic metal layer 41 is formed by sputtering, for example. The nonmagnetic metal layer 41 is formed to have a thickness within a range of 0.7 to 3.0 nm, for example.

Next, a protection layer 42 for preventing oxidation or nitriding of the nonmagnetic metal layer 41 is formed on the nonmagnetic metal layer 41. The material of the protection layer 42 is preferably a nonmagnetic metal material that is resistant to oxidization and nitriding and that is different from the nonmagnetic metal material used to form the nonmagnetic metal layer 41. For example, the nonmagnetic metal material used to form the protection layer 42 can be one of Au and Ru, of which Au is preferred. Alternatively, the nonmagnetic metal material used to form the protection layer 42 may be an AuCu alloy having a Cu content of 20 atomic percent or lower. The protection layer 42 is formed by sputtering, for example. The protection layer 42 is formed to have a thickness within a range of 0.5 to 1 nm, for example.

Next, a layer having an island-shaped structure (hereinafter referred to as an island-shaped layer) 43 is formed on the protection layer 42. The island-shaped layer 43 is made of a nonmagnetic metal material, and will be later subjected to oxidation or nitriding to thereby become an insulating layer. Examples of the material of the island-shaped layer 43 include Ti, Zr, Hf, Nb and Cr. The island-shaped layer 43 is formed by sputtering or vacuum deposition, for example. The island-shaped layer 43 is formed to have a thickness within a range of 0.3 to 0.5 nm, for example.

Next, as shown in FIG. 10, the island-shaped layer 43 is subjected to oxidization or nitriding to thereby become the insulating layer 44 having an island-shaped structure. Therefore, the insulating layer 44 is made of an oxide or a nitride of a nonmagnetic metal material. This step is performed by, for example, leaving the stack of layers in an atmosphere containing at least one of oxygen and nitrogen. In this step, since the protection layer 42 is present between the nonmagnetic metal layer 41 and the island-shaped layer 43, the nonmagnetic metal layer 41 is prevented from being oxidized or nitrided upon the oxidation or nitriding of the island-shaped layer 43.

Next, as shown in FIG. 11, the protection layer 42 is partially etched using the insulating layer 44 as a mask. The etching in this step is performed by dry etching using plasma, for example. In this step, the etching may be performed such that a groove 45 formed in the protection layer 42 through this etching would not penetrate the protection layer 42, or may be performed such that the groove 45 penetrates the protection layer 42. In the case of performing the etching such that the groove 45 penetrates the protection layer 42, part of the nonmagnetic metal layer 41 may also be etched so that the bottom of the groove 45 is formed in the nonmagnetic metal layer 41. In this case, however, the groove 45 should not penetrate the nonmagnetic metal layer 41. This step is performed such that the insulating layer 44 remains on the protection layer 42. The depth of the groove formed in the protection layer 42 or in the protection layer 42 and the nonmagnetic metal layer 41 through the etching, which will be hereinafter referred to as “etch depth”, is preferably within a range of 50 to 125 percent of the thickness of the protection layer 42 before the etching is performed, in view of experimental results that will be shown later.

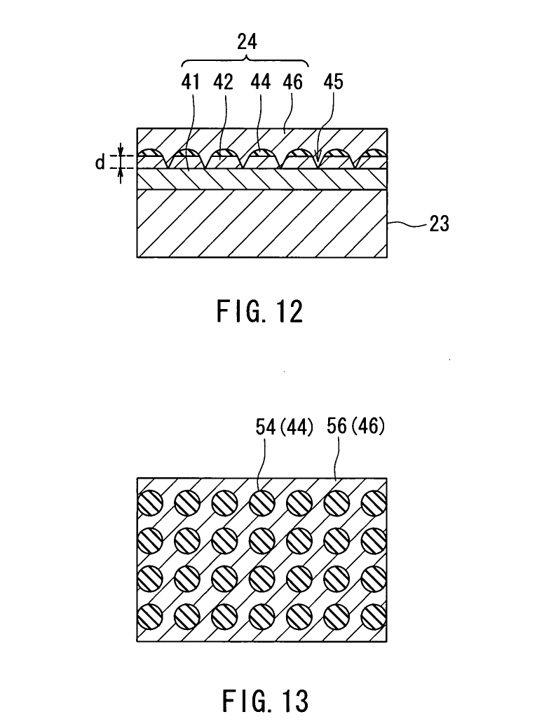

Next, as shown in FIG. 12, a coating layer 46 made of a nonmagnetic metal material is formed to cover the nonmagnetic metal layer 41, the protection layer 42 and the insulating layer 44. For example, the nonmagnetic metal material used to form the coating layer 46 can be one of Cu and Ag, of which Cu is preferred. The coating layer 46 is formed by sputtering, for example. The coating layer 46 is formed to have a maximum thickness of 0.7 to 3.0 nm, for example.

The spacer layer 24 is formed through the foregoing steps. Then, the free layer 25 is formed on the spacer layer 24. Alternatively, the step illustrated in FIG. 12 can be dispensed with, so that the free layer 25 may be formed to cover the nonmagnetic metal layer 41, the protection layer 42 and the insulating layer 44 without forming the coating layer 46 after the step illustrated in FIG. 11.

The spacer layer 24 of the embodiment includes: the nonmagnetic metal layer 41 disposed on the pinned layer 23; the protection layer 42 disposed on the nonmagnetic metal layer 41 to prevent oxidation or nitriding of the nonmagnetic metal layer 41; the insulating layer 44 disposed on the protection layer 42; and the coating layer 46 disposed to cover the nonmagnetic metal layer 41, the protection layer 42 and the insulating layer 44.

FIG. 13 illustrates a cross section of the spacer layer 24 that passes through the insulating layer 44 and is parallel to the bottom surface of the spacer layer 24. The spacer layer 24 includes the insulating portion 54 and the conducting portion 56 such that the insulating portion 54 and the conducting portion 56 are both present in this cross section. The insulating portion 54 is composed of the insulating layer 44 while the conducting portion 56 is composed of the coating layer 46. In the case where the coating layer 46 is not formed but the free layer 25 is formed to cover the nonmagnetic metal layer 41, the protection layer 42 and the insulating layer 44, the conducting portion 56 is composed of the free layer 25.

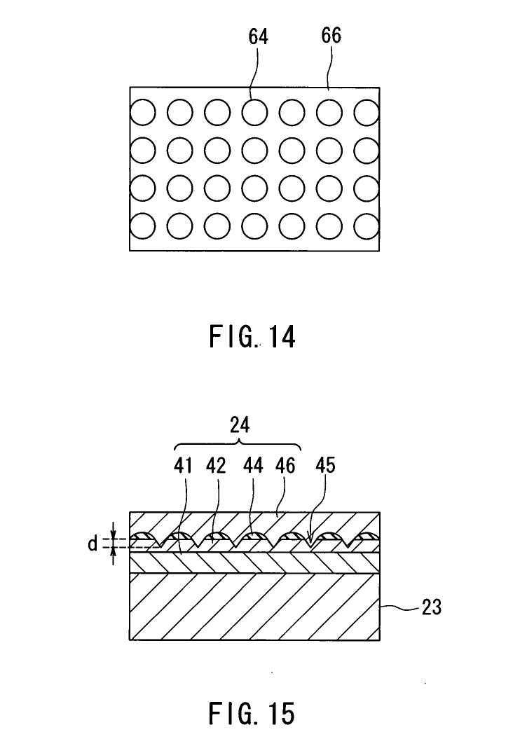

FIG. 14 schematically illustrates two regions in the spacer layer 24 when seen in the direction perpendicular to the top surface of the pinned layer 23. As illustrated in FIG. 14, when seen in the direction perpendicular to the top surface of the pinned layer 23, there are formed in the spacer layer 24 a region 64 where the insulating layer 44 is present and a region 66 where the insulating layer 44 is absent. The conducting portion 56 composed of the coating layer 46 is located in the region 66 where the insulating layer 44 is absent. A thickness of the protection layer 42 taken in at least part of the region 66 where the insulating layer 44 is absent is zero or smaller than a thickness of the protection layer 42 taken in the region 64 where the insulating layer 44 is present.

Here, as illustrated in FIG. 12, “d” represents the maximum difference in level between the top surface of the protection layer 42 in the region 64 where the insulating layer 44 is present and the top surface of either the protection layer 42 or the nonmagnetic metal layer 41 in the region 66 where the insulating layer 44 is absent. This difference in level “d” is equal to the etch depth mentioned previously. From the experimental results described later, it is preferred that this difference in level “d” fall within a range of 50 to 125 percent of the thickness of the protection layer 42 taken in the region 64 where the insulating layer 44 is present.

FIG. 12 illustrates an example in which the difference in level “d” is equal to 100% of the thickness of the protection layer 42 taken in the region 64 where the insulating layer 44 is present. In this case, the thickness of the protection layer 42 taken in at least part of the region 66 where the insulating layer 44 is absent is zero.

FIG. 15 illustrates an example in which the difference in level “d” is smaller than 100% of the thickness of the protection layer 42 taken in the region 64 where the insulating layer 44 is present. In this case, the thickness of the protection layer 42 taken in at least part of the region 66 where the insulating layer 44 is absent is not zero, but smaller than the thickness of the protection layer 42 taken in the region 64 where the insulating layer 44 is present.

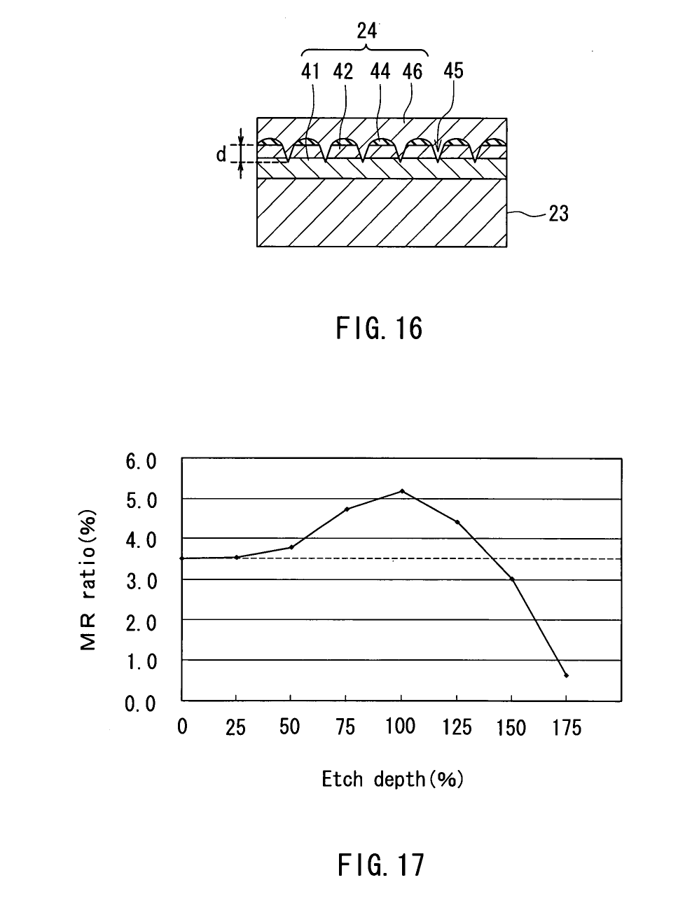

FIG. 16 illustrates an example in which the difference in level “d” is greater than 100% of the thickness of the protection layer 42 taken in the region 64 where the insulating layer 44 is present. In this case, the thickness of the protection layer 42 taken in at least part of the region 66 where the insulating layer 44 is absent is zero.

According to the spacer layer 24 of the embodiment, oxidation or nitriding of the nonmagnetic metal layer 41 due to the formation of the insulating layer 44 is prevented by the protection layer 42. Therefore, according to the embodiment, it is possible to suppress degradation of the magnetoresistive effect of the MR element 5, such as a reduction in MR ratio, resulting from the formation of the insulating layer 44.

In the spacer layer 24 of the embodiment, the thickness of the protection layer 42 taken in at least part of the region 66 where the insulating layer 44 is absent is zero or smaller than the thickness of the protection layer 42 taken in the region 64 where the insulating layer 44 is present. Consequently, in the spacer layer 24 of the embodiment, the distance over which a sense current passes through the protection layer 42 is shorter, compared with a case where the thickness of the protection layer 42 taken in the region 66 where the insulating layer 44 is absent is equal to the thickness of the protection layer 42 taken in the region 64 where the insulating layer 44 is present. As a result, according to the embodiment, it is possible to suppress degradation of the magnetoresistive effect of the MR element 5, such as a reduction in MR ratio, attributable to the protection layer 42.

These features of the embodiment make it possible to suppress degradation of the magnetoresistive effect of the MR element 5, such as a reduction in MR ratio, resulting from the formation of the insulating portion 54 (the insulating layer 44) of the spacer layer 24.

### [First Experiment]

A description will now be given of a first experiment performed for determining a preferable range of the difference in level d, that is, the etch depth, mentioned previously. In this experiment, a plurality of samples of the MR element 5 were fabricated with different etch depths by altering the etch period of the step illustrated in FIG. 11. Table 1 below shows the specific film configuration of these samples. Hereinafter, a CoFe alloy containing 70 atomic percent Co and 30 atomic percent Fe is represented by CO₇₀Fe₃₀, while an oxide of Ti is represented by TiOₓ.

TABLE 1

| Layer | | Material | Thickness (nm) |
|---|---|---|---|
| Protection layer | | Ru | 10 |
| Free layer | | Co₇₀Fe₃₀ | 4 |
| Spacer layer | | Cu | 1.5 |
| | | TiOₓ | |
| | | Au | 1 |
| | | Cu | 1 |
| Pinned | Inner layer | Co₇₀Fe₃₀ | 4 |
| layer | Nonmagnetic middle layer | Ru | 0.8 |
| | Outer layer | Co₇₀Fe₃₀ | 4 |

| | | |
|---|---|---|
| Antiferromagnetic layer | IrMn | 7 |
| Underlying layer | Ru | 5 |
| | Ta | 5 |

In the spacer layer listed on Table 1, the lowermost Cu layer corresponds to the nonmagnetic metal layer 41, the Au layer thereabove corresponds to the protection layer 42, the TiOₓ layer thereabove corresponds to the insulating layer 44, and the Cu layer thereabove corresponds to the coating layer 46. The temperature of the substrate 1 when forming the Au layer was 20° C. The TiOₓ layer was formed through forming a 0.4-nm-thick island-shaped Ti layer as the island-shaped layer made of a nonmagnetic material, and then allowing this Ti layer to undergo natural oxidation in an oxygen atmosphere. Etching of the Au layer (the protection layer 42) using the TiOₓ layer (the insulating layer 44) as a mask was performed by dry etching using plasma.

In the first experiment, a comparative example against the above samples was also fabricated. The configuration of this comparative example is the same as that of the above samples except that the comparative example does not have the protection layer 42 (Au layer). Table 2 below lists the specific film configuration of the comparative example.

TABLE 2

| Layer | | Material | Thickness (nm) |
|---|---|---|---|
| Protection layer | | Ru | 10 |
| Free layer | | Co₇₀Fe₃₀ | 4 |
| Spacer layer | | Cu | 1.5 |
| | | TiOₓ | |
| | | Cu | 1 |
| Pinned | Inner layer | Co₇₀Fe₃₀ | 4 |
| layer | Nonmagnetic middle layer | Ru | 0.8 |
| | Outer layer | Co₇₀Fe₃₀ | 4 |

| | | |
|---|---|---|
| Antiferromagnetic layer | IrMn | 7 |
| Underlying layer | Ru | 5 |
| | Ta | 5 |

In the first experiment, MR ratio was measured for each of the plurality of samples and the comparative example fabricated. The MR ratio of the comparative example was approximately 4.0%. Table 3 below shows the relationship among the etch period, the etch depth and the MR ratio in the plurality of samples. FIG. 17 illustrates the relationship between the etch depth and the MR ratio in the plurality of samples. The etch depth is expressed as a percent with respect to the thickness of the protection layer 42 before the etching is performed.

TABLE 3

| Etch period (sec) | Etch depth (%) | MR ratio (%) |
|---|---|---|
| 0 | 0 | 3.5 |
| 10 | 25 | 3.5 |
| 20 | 50 | 3.8 |
| 30 | 75 | 4.7 |
| 40 | 100 | 5.2 |
| 50 | 125 | 4.4 |
| 60 | 150 | 3.0 |
| 70 | 175 | 0.6 |

According to the results of the first experiment, as shown in Table 3 and FIG. 17, the MR ratio is maximum when the etch depth is 100 percent, and the MR ratio decreases as the etch depth gets away from 100 percent. The MR ratio obtained when the etch depth is within a range of 50 to 125 percent is higher than that in the case where the etch depth is 0 percent, which indicates that the effect of the etching appears at least within this range. This teaches that, according to the embodiment, it is preferred that the etch depth be within a range of 50 to 125 percent, that is, the difference in level “d” be within a range of 50 to 125 percent of the thickness of the protection layer 42 taken in the region 64 where the insulating layer 44 is present.

When the etch depth is within a range of 75 to 125 percent, an MR ratio higher than the MR ratio of the comparative example is obtained. This teaches that it is more preferred that the etch depth be within a range of 75 to 125 percent, that is, the difference in level “d” be within a range of 75 to 125 percent of the thickness of the protection layer 42 taken in the region 64 where the insulating layer 44 is present.

### [Second Experiment]

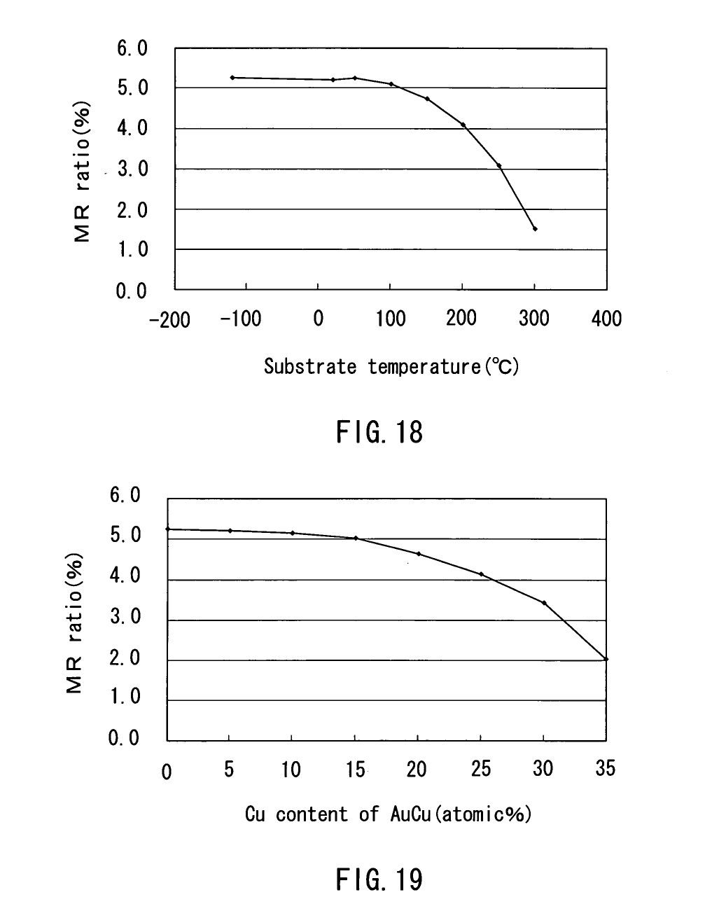

A description will now be given of a second experiment performed for determining a preferable temperature range to be employed in the step of forming the protection layer 42 in the case where the nonmagnetic metal material used to form the nonmagnetic metal layer 41 is Cu and the material used to form the protection layer 42 is Au. In the second experiment, a plurality of samples of the MR element 5 were fabricated by varying the temperature of the substrate 1 (hereinafter referred to as the substrate temperature) when forming a Au layer as the protection layer 42. The specific film configuration of the samples fabricated in the second experiment is the same as that of the samples of the first experiment, which is shown on Table 1. The etch depth is 100 percent for all of the samples fabricated in the second experiment. MR ratio was also measured for each of the plurality of samples fabricated in the second experiment. Table 4 below and FIG. 18 show the relationship between the substrate temperature and the MR ratio in the plurality of samples fabricated in the second experiment.

TABLE 4

| Substrate | |
|---|---|
| temperature (° C.) | MR ratio (%) |
| −120 | 5.2 |
| 20 | 5.2 |
| 50 | 5.2 |
| 100 | 5.1 |
| 150 | 4.7 |
| 200 | 4.1 |
| 250 | 3.1 |
| 300 | 1.5 |

As shown in Table 4 and FIG. 18, a high MR ratio is obtained when the substrate temperature is 100° C. or lower. When the substrate temperature is 150° C., the MR ratio is slightly lower than that obtained when the substrate temperature is 100° C. or lower, but it is sufficiently higher than the MR ratio of the comparative example fabricated in the first experiment. When the substrate temperature is higher than 150° C., however, a reduction in MR ratio is noticeable. A conceivable reason for the reduction in MR ratio at higher substrate temperatures is that, when the substrate temperature gets higher, mutual diffusion of Cu that forms the nonmagnetic metal layer 41 and Au that forms the protection layer 42 becomes noticeable and the function of the protection layer 42 for preventing oxidation of the nonmagnetic metal layer 41 is thereby degraded. The results of the second experiment indicate that, when the nonmagnetic metal material used to form the nonmagnetic metal layer 41 is Cu and the material used to form the protection layer 42 is Au, the step of forming the protection layer 42 should preferably be performed at a temperature of 150° C. or lower, and more preferably at a temperature of 100° C. or lower.

### [Third Experiment]

A description will now be given of a third experiment performed for determining a preferable range of the Cu content of an AuCu alloy employed as the material of the protection layer 42. In the third experiment, fabricated were a sample of the MR element 5 employing Au as the material of the protection layer 42 and a plurality of samples of the MR element 5 employing AuCu alloy as the material of the protection layer 42 with the Cu content varied. Table 5 below shows the specific film configuration of the samples in which AuCu alloy was employed as the material of the protection layer 42.

TABLE 5

| Layer | | Material | Thickness (nm) |
|---|---|---|---|
| Protection layer | | Ru | 10 |
| Free layer | | Co₇₀Fe₃₀ | 4 |
| Spacer layer | | Cu | 1.5 |
| | | TiOₓ | |
| | | AuCu | 1 |
| | | Cu | 1 |
| Pinned | Inner layer | Co₇₀Fe₃₀ | 4 |
| layer | Nonmagnetic middle layer | Ru | 0.8 |
| | Outer layer | Co₇₀Fe₃₀ | 4 |

| | | |
|---|---|---|
| Antiferromagnetic layer | IrMn | 7 |
| Underlying layer | Ru | 5 |
| | Ta | 5 |

In the spacer layer listed on Table 5, the AuCu layer corresponds to the protection layer 42. The temperature of the substrate 1 when forming the AuCu layer was 20° C. The configuration of the layers of the samples fabricated in the third experiment except the protection layer 42 is the same as that of the samples fabricated in the first experiment. The etch depth is 100% for all of the samples fabricated in the third experiment.

In the third experiment, MR ratio was also measured for each of the plurality of samples fabricated. Table 6 below and FIG. 19 show the relationship between the MR ratio and the Cu content of AuCu in the plurality of samples fabricated in the third experiment. While Table 6 and FIG. 19 include a case where the Cu content is O atomic percent for convenience, this is the case where the material of the protection layer 42 is not AuCu but Au.

TABLE 6

| Cu content of AuCu | |
|---|---|
| (atomic %) | MR ratio (%) |
| 0 | 5.2 |
| 5 | 5.2 |
| 10 | 5.2 |
| 15 | 5.0 |
| 20 | 4.6 |
| 25 | 4.1 |
| 30 | 3.4 |
| 35 | 2.1 |

As shown in Table 6 and FIG. 19, a high MR ratio is obtained when the Cu content is 15 percent or lower. When the Cu content is 20 percent, the MR ratio is slightly lower than that obtained when the Cu content is 15 percent or lower, but it is sufficiently higher than the MR ratio of the comparative example fabricated in the first experiment. When the Cu content is higher than 20 percent, however, a reduction in MR ratio is noticeable. A conceivable reason why the MR ratio decreases as the Cu content increases is that a reduction in Au content of AuCu results in degradation of the function of the protection layer 42 for preventing oxidation of the nonmagnetic metal layer 41. The results of the third experiment indicate that, when the nonmagnetic metal material used to form the protection layer 42 is an AuCu alloy, the Cu content should preferably be 20 atomic percent or lower, and more preferably be 15 atomic percent or lower.

In the first to third experiments, the insulating layer 44 was formed by oxidizing an island-shaped layer made of a nonmagnetic material. It is needless to say that, however, in the case where the insulating layer 44 is formed by nitriding the island-shaped layer made of a nonmagnetic material, it is possible to obtain effects similar to those obtained in the first third experiments.

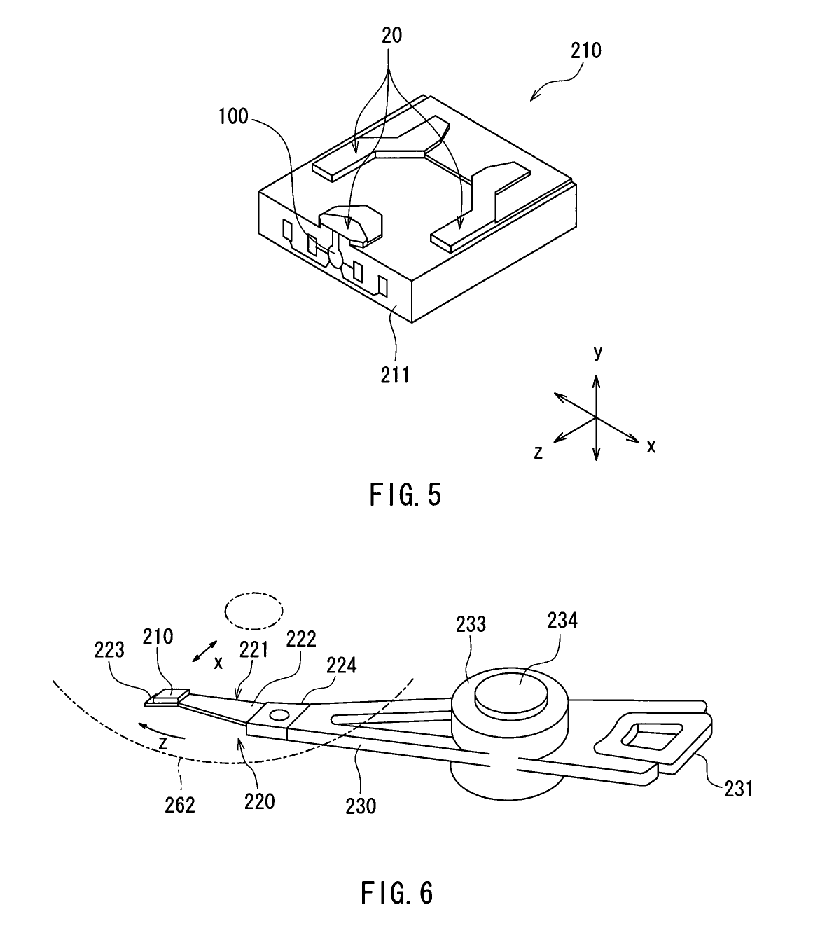

A head gimbal assembly, a head arm assembly and a magnetic disk drive of the embodiment will now be described. Reference is now made to FIG. 5 to describe a slider 210 incorporated in the head gimbal assembly. In the magnetic disk drive, the slider 210 is placed to face toward a magnetic disk platter that is a circular-plate-shaped recording medium to be driven to rotate. The slider 210 has a base body 211 made up mainly of the substrate 1 and the overcoat layer 17 of FIG. 3. The base body 211 is nearly hexahedron-shaped. One of the six surfaces of the base body 211 faces toward the magnetic disk platter. The medium facing surface 20 is formed in this one of the surfaces. When the magnetic disk platter rotates in the z direction of FIG. 5, an airflow passes between the magnetic disk platter and the slider 210, and a lift is thereby generated below the slider 210 in the y direction of FIG. 5 and exerted on the slider 210. The slider 210 flies over the magnetic disk platter by means of the lift. The x direction of FIG. 5 is across the tracks of the magnetic disk platter. A thin-film magnetic head 100 of the embodiment is formed near the air-outflow-side end (the end located at the lower left of FIG. 5) of the slider 210.

Reference is now made to FIG. 6 to describe the head gimbal assembly 220 of the embodiment. The head gimbal assembly 220 incorporates the slider 210 and a suspension 221 that flexibly supports the slider 210. The suspension 221 incorporates: a plate-spring-shaped load beam 222 made of stainless steel, for example; a flexure 223 to which the slider 210 is joined, the flexure 223 being located at an end of the load beam 222 and giving an appropriate degree of freedom to the slider 210; and a base plate 224 located at the other end of the load beam 222. The base plate 224 is attached to an arm 230 of an actuator for moving the slider 210 along the x direction across the tracks of the magnetic disk platter 262. The actuator incorporates the arm 230 and a voice coil motor that drives the arm 230. A gimbal section for maintaining the orientation of the slider 210 is provided in the portion of the flexure 223 on which the slider 210 is mounted.

The head gimbal assembly 220 is attached to the arm 230 of the actuator. An assembly including the arm 230 and the head gimbal assembly 220 attached to the arm 230 is called a head arm assembly. An assembly including a carriage having a plurality of arms wherein the head gimbal assembly 220 is attached to each of the arms is called a head stack assembly.

FIG. 6 illustrates the head arm assembly of the embodiment. In the head arm assembly, the head gimbal assembly 220 is attached to an end of the arm 230. A coil 231 that is part of the voice coil motor is fixed to the other end of the arm 230. A bearing 233 is provided in the middle of the arm 230. The bearing 233 is attached to a shaft 234 that rotatably supports the arm 230.

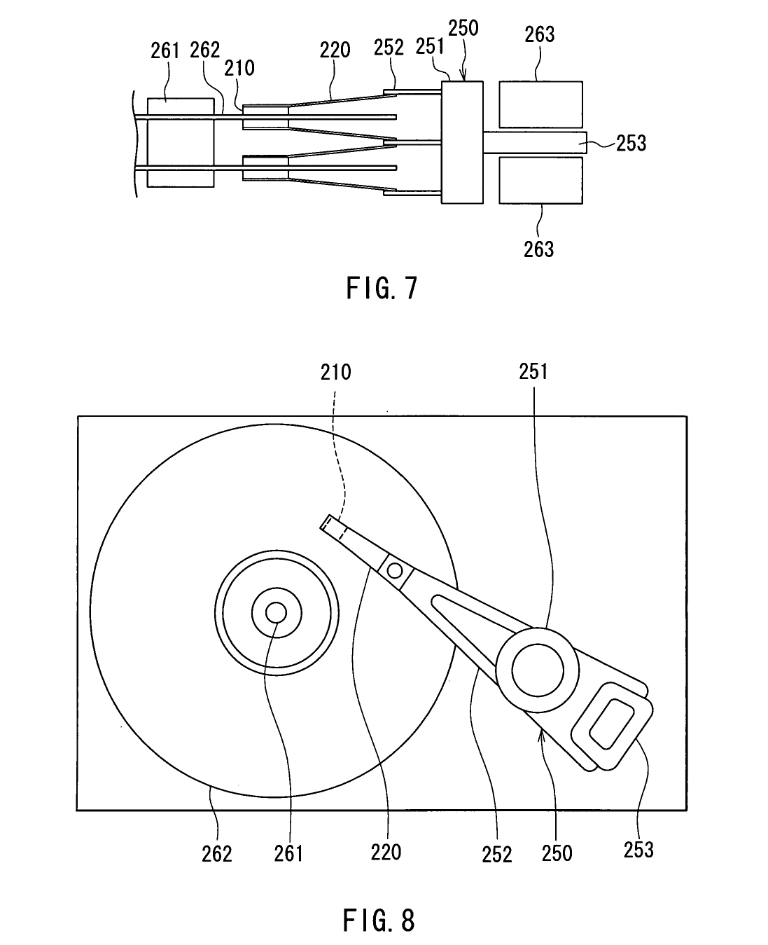

Reference is now made to FIG. 7 and FIG. 8 to describe an example of the head stack assembly and the magnetic disk drive of the embodiment. FIG. 7 illustrates the main part of the magnetic disk drive. FIG. 8 is a top view of the magnetic disk drive. The head stack assembly 250 incorporates a carriage 251 having a plurality of arms 252. A plurality of head gimbal assemblies 220 are attached to the arms 252 such that the assemblies 220 are arranged in the vertical direction with spacing between adjacent ones. A coil 253 that is part of the voice coil motor is mounted on the carriage 251 on a side opposite to the arms 252. The head stack assembly 250 is installed in the magnetic disk drive. The magnetic disk drive includes a plurality of magnetic disk platters 262 mounted on a spindle motor 261. Two of the sliders 210 are allocated to each of the platters 262, such that the two sliders 210 are opposed to each other with each of the platters 262 disposed in between. The voice coil motor includes permanent magnets 263 disposed to be opposed to each other, the coil 253 of the head stack assembly 250 being placed between the magnets 263.

The actuator and the head stack assembly 250 except the sliders 210 correspond to the alignment device of the invention and support the sliders 210 and align them with respect to the magnetic disk platters 262.

In the magnetic disk drive of the embodiment, the actuator moves the slider 210 across the tracks of the magnetic disk platter 262 and aligns the slider 210 with respect to the magnetic disk platter 262. The thin-film magnetic head incorporated in the slider 210 writes data on the magnetic disk platter 262 through the use of the write head and reads data stored on the magnetic disk platter 262 through the use of the read head.

The head gimbal assembly, the head arm assembly and the magnetic disk drive of the embodiment exhibit effects similar to those of the foregoing thin-film magnetic head of the embodiment.

### Second Embodiment

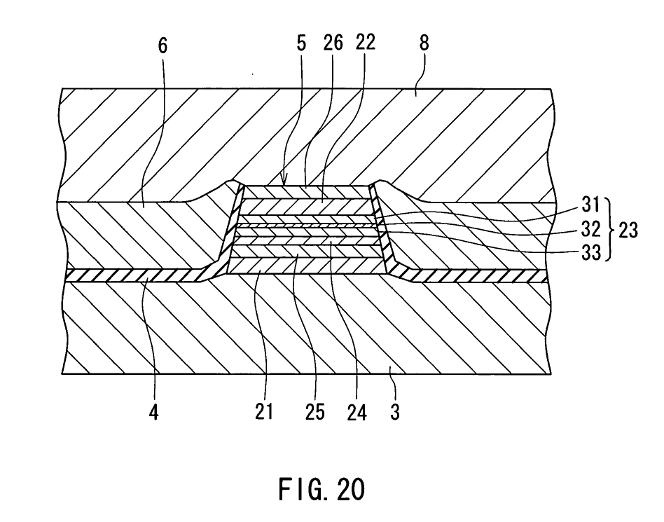

A second embodiment of the invention will now be described with reference to FIG. 20. FIG. 20 is a cross-sectional view illustrating a cross section of a read head of the second embodiment parallel to the medium facing surface. The configuration of the read head of the second embodiment is the same as that of the first embodiment except the configuration of the MR element 5. The MR element 5 of the second embodiment includes: an underlying layer 21, a free layer 25, a spacer layer 24, a pinned layer 23, an antiferromagnetic layer 22 and a protection layer 26 that are stacked in this order on the first shield layer 3. Thus, in the MR element 5 of the second embodiment, the free layer 25 is disposed closer to the first shield layer 3 than is the pinned layer 23. In the second embodiment, the free layer 25 corresponds to the first magnetic layer of the invention, while the pinned layer 23 corresponds to the second magnetic layer of the invention.

The pinned layer 23 of the second embodiment is a so-called synthetic pinned layer, having an inner layer 33, a nonmagnetic middle layer 32 and an outer layer 31 that are stacked in this order on the spacer layer 24.

The underlying layer 21 of the second embodiment is a NiCr layer, for example. The protection layer 26 of the second embodiment is a Ru layer, for example. The thicknesses and materials of the other layers constituting the MR element 5 of the second embodiment are the same as those of the first embodiment.

The method of manufacturing the MR element 5 of the second embodiment includes the steps of forming the underlying layer 21, the free layer 25, the spacer layer 24, the pinned layer 23, the antiferromagnetic layer 22 and the protection layer 26 in this order on the first shield layer 3. The layers except the spacer layer 24 are formed by sputtering, for example. In the second embodiment, the step of forming the free layer 25 corresponds to the step of forming the first magnetic layer of the invention, while the step of forming the pinned layer 23 corresponds to the step of forming the second magnetic layer of the invention. The method of forming the spacer layer 24 of the second embodiment is the same as that of the first embodiment.

Table 7 below shows an example of the specific film configuration of the MR element of the second embodiment. In the spacer layer listed on Table 7, the lowermost Cu layer corresponds to the nonmagnetic metal layer 41, the Au layer thereabove corresponds to the protection layer 42, the TiOₓ layer thereabove corresponds to the insulating layer 44, and the Cu layer thereabove corresponds to the coating layer 46.

TABLE 7

| Layer | | Material | Thickness (nm) |
|---|---|---|---|
| Protection layer | | Ru | 10 |
| Antiferromagnetic layer | | IrMn | 7 |
| Pinned | Outer layer | Co₇₀Fe₃₀ | 4 |
| layer | Nonmagnetic middle layer | Ru | 0.8 |
| | Inner layer | Co₇₀Fe₃₀ | 4 |

| | | |
|---|---|---|
| Spacer layer | Cu | 1.5 |
| | TiOₓ | |
| | Au | 1 |
| | Cu | 1 |
| Free layer | Co₇₀Fe₃₀ | 4 |
| Underlying layer | NiCr | 4 |

The remainder of configuration, function and effects of the second embodiment are similar to those of the first embodiment.

The present invention is not limited to the foregoing embodiments but various modifications are possible. For example, the pinned layer 23 is not limited to a synthetic pinned layer. In addition, while the embodiments have been described with reference to a magnetic head having a structure in which the read head is formed on the base body and the write head is stacked on the read head, the read head and the write head may be stacked in the reverse order. Furthermore, when the magnetic head is to be used only for read operations, the head may be configured to include only the read head.

It is apparent that the present invention can be carried out in various forms and modifications in the light of the foregoing descriptions. Accordingly, within the scope of the following claims and equivalents thereof, the present invention can be carried out in forms other than the foregoing most preferable embodiments.

What is claimed is:

1. A magnetoresistive element comprising:
a first magnetic layer;
a second magnetic layer; and
a spacer layer disposed between the first magnetic layer and the second magnetic layer, wherein:
one of the first magnetic layer and the second magnetic layer is a layer whose direction of magnetization is fixed;
the other of the first magnetic layer and the second magnetic layer is a layer whose direction of magnetization changes in response to an external magnetic field;
the spacer layer includes an insulating portion and a conducting portion such that the insulating portion and the conducting portion are both present in a cross section parallel to a plane of the spacer layer; and
a current for detecting magnetic signals is fed in a direction intersecting the plane of each layer making up the magnetoresistive element,
the spacer layer including:
a nonmagnetic metal layer made of a nonmagnetic metal material and disposed on the first magnetic layer;
a protection layer disposed on the nonmagnetic metal layer to prevent oxidation or nitriding of the nonmagnetic metal layer; and
an insulating layer disposed on the protection layer and constituting the insulating portion, wherein:
when seen in a direction perpendicular to a top surface of the first magnetic layer, there are formed in the spacer layer a region where the insulating layer is present and a region where the insulating layer is absent;
the conducting portion is located in the region where the insulating layer is absent; and
a thickness of the protection layer taken in at least part of the region where the insulating layer is absent is zero or smaller than a thickness of the protection layer taken in the region where the insulating layer is present.

2. The magnetoresistive element according to claim 1, wherein the nonmagnetic metal material used to form the nonmagnetic metal layer is Cu.

3. The magnetoresistive element according to claim 1, wherein the protection layer is made of a nonmagnetic metal material that is different from the nonmagnetic metal material used to form the nonmagnetic metal layer.

4. The magnetoresistive element according to claim 3, wherein the nonmagnetic metal material used to form the protection layer is Au.

5. The magnetoresistive element according to claim 3, wherein the nonmagnetic metal material used to form the protection layer is an AuCu alloy having a Cu content of 20 atomic percent or lower.

6. The magnetoresistive element according to claim 1, wherein the insulating layer is made of an oxide or a nitride of a nonmagnetic metal material.

7. The magnetoresistive element according to claim 6, wherein the insulating layer is made of an oxide or a nitride of any of Ti, Zr, Hf, Nb and Cr.

8. The magnetoresistive element according to claim 1, wherein the spacer layer further includes a coating layer made of a nonmagnetic metal material, disposed to cover the nonmagnetic metal layer, the protection layer and the insulating layer and constituting the conducting portion.

9. The magnetoresistive element according to claim 8, wherein the nonmagnetic metal material used to form the coating layer is Cu.

10. The magnetoresistive element according to claim 1, wherein a maximum difference in level between a top surface of the protection layer in the region where the insulating layer is present and a top surface of either the protection layer or the nonmagnetic metal layer in the region where the insulating layer is absent is within a range of 50 to 125 percent of the thickness of the protection layer taken in the region where the insulating layer is present.

11. A method of manufacturing a magnetoresistive element comprising:
a first magnetic layer; a second magnetic layer; and a spacer layer disposed between the first magnetic layer and the second magnetic layer, wherein:
one of the first magnetic layer and the second magnetic layer is a layer whose direction of magnetization is fixed;
the other of the first magnetic layer and the second magnetic layer is a layer whose direction of magnetization changes in response to an external magnetic field;
the spacer layer includes an insulating portion and a conducting portion such that the insulating portion and the conducting portion are both present in a cross section parallel to a plane of the spacer layer; and
a current for detecting magnetic signals is fed in a direction intersecting the plane of each layer making up the magnetoresistive element,
the method comprising the steps of:
forming the first magnetic layer;
forming the spacer layer on the first magnetic layer; and
forming the second magnetic layer on the spacer layer, wherein:
the step of forming the spacer layer includes the steps of: forming a nonmagnetic metal layer made of a nonmagnetic metal material on the first magnetic layer;
forming a protection layer for preventing oxidation or nitriding of the nonmagnetic metal layer on the nonmagnetic metal layer;
forming an insulating layer constituting the insulating portion on the protection layer; and
partially etching the protection layer using the insulating layer as a mask, wherein:
when seen in a direction perpendicular to a top surface of the first magnetic layer, there are formed in the spacer layer a region where the insulating layer is present and a region where the insulating layer is absent;
the conducting portion is formed to be located in the region where the insulating layer is absent; and
a thickness of the protection layer taken in at least part of the region where the insulating layer is absent is zero or smaller than a thickness of the protection layer taken in the region where the insulating layer is present.

12. The method according to claim 11, wherein the nonmagnetic metal material used to form the nonmagnetic metal layer is Cu.

13. The method according to claim 11, wherein the protection layer is made of a nonmagnetic metal material that is different from the nonmagnetic metal material used to form the nonmagnetic metal layer.

14. The method according to claim 13, wherein the nonmagnetic metal material used to form the protection layer is Au.

15. The method according to claim 13, wherein the nonmagnetic metal material used to form the protection layer is an AuCu alloy having a Cu content of 20 atomic percent or lower.

16. The method according to claim 11, wherein the step of forming the insulating layer includes the steps of forming an island-shaped layer made of a nonmagnetic metal material on the protection layer, the island-shaped layer being intended to become the insulating layer by undergoing oxidation or nitriding; and causing the island-shaped layer to become the insulating layer by subjecting the island-shaped layer to oxidation or nitriding.

17. The method according to claim 16, wherein the nonmagnetic metal material used to form the island-shaped layer is any of Ti, Zr, Hf, Nb and Cr.

18. The method according to claim 11, wherein the step of forming the spacer layer further includes the step of forming a coating layer to cover the nonmagnetic metal layer, the protection layer and the insulating layer, the coating layer being made of a nonmagnetic metal material and constituting the conducting portion.

19. The method according to claim 18, wherein the nonmagnetic metal material used to form the coating layer is Cu.

20. The method according to claim 11, wherein, in the step of partially etching the protection layer, a portion of the protection layer or a portion of each of the protection layer and the nonmagnetic metal layer is etched such that a maximum difference in level between a top surface of the protection layer in the region where the insulating layer is present and a top surface of either the protection layer or the nonmagnetic metal layer in the region where the insulating layer is absent falls within a range of 50 to 125 percent of the thickness of the protection layer taken in the region where the insulating layer is present.

21. The method according to claim 11, wherein:
the nonmagnetic metal material used to form the nonmagnetic metal layer is Cu and the material used to form the protection layer is Au; and
the step of forming the protection layer is performed at a temperature of 150° C. or lower.

22. A thin-film magnetic head comprising: a medium facing surface that faces toward a recording medium; a magnetoresistive element disposed near the medium facing surface to detect a signal magnetic field sent from the recording medium; and a pair of electrodes for feeding a current for detecting magnetic signals to the magetoresistive element,
the magetoresistive element comprising:
a first magnetic layer;
a second magnetic layer; and
a spacer layer disposed between the first magnetic layer and the second magnetic layer, wherein:
one of the first magnetic layer and the second magnetic layer is a layer whose direction of magnetization is fixed;
the other of the first magnetic layer and the second magnetic layer is a layer whose direction of magnetization changes in response to an external magnetic field;
the spacer layer includes an insulating portion and a conducting portion such that the insulating portion and the conducting portion are both present in a cross section parallel to a plane of the spacer layer; and
in the magnetoresistive element, the current for detecting magnetic signals is fed in a direction intersecting the plane of each layer making up the magnetoresistive element,
the spacer layer including:
a nonmagnetic metal layer made of a nonmagnetic metal material and disposed on the first magnetic layer;
a protection layer disposed on the nonmagnetic metal layer to prevent oxidation or nitriding of the nonmagnetic metal layer; and
an insulating layer disposed on the protection layer and constituting the insulating portion, wherein:
when seen in a direction perpendicular to a top surface of the first magnetic layer, there are formed in the spacer layer a region where the insulating layer is present and a region where the insulating layer is absent;
the conducting portion is located in the region where the insulating layer is absent; and
a thickness of the protection layer taken in at least part of the region where the insulating layer is absent is zero or smaller than a thickness of the protection layer taken in the region where the insulating layer is present.

23. A head gimbal assembly comprising: a slider including a thin-film magnetic head and disposed to face toward a recording medium; and a suspension flexibly supporting the slider,
the thin-film magnetic head comprising: a medium facing surface that faces toward the recording medium; a magnetoresistive element disposed near the medium facing surface to detect a signal magnetic field sent from the recording medium; and a pair of electrodes for feeding a current for detecting magnetic signals to the magetoresistive element,
the magetoresistive element comprising:
a first magnetic layer;
a second magnetic layer; and
a spacer layer disposed between the first magnetic layer and the second magnetic layer, wherein:
one of the first magnetic layer and the second magnetic layer is a layer whose direction of magnetization is fixed;
the other of the first magnetic layer and the second magnetic layer is a layer whose direction of magnetization changes in response to an external magnetic field;
the spacer layer includes an insulating portion and a conducting portion such that the insulating portion and the conducting portion are both present in a cross section parallel to a plane of the spacer layer; and
in the magnetoresistive element, the current for detecting magnetic signals is fed in a direction intersecting the plane of each layer making up the magnetoresistive element,
the spacer layer including:
a nonmagnetic metal layer made of a nonmagnetic metal material and disposed on the first magnetic layer;
a protection layer disposed on the nonmagnetic metal layer to prevent oxidation or nitriding of the nonmagnetic metal layer; and
an insulating layer disposed on the protection layer and constituting the insulating portion, wherein:
when seen in a direction perpendicular to a top surface of the first magnetic layer, there are formed in the spacer layer a region where the insulating layer is present and a region where the insulating layer is absent;
the conducting portion is located in the region where the insulating layer is absent; and
a thickness of the protection layer taken in at least part of the region where the insulating layer is absent is zero or smaller than a thickness of the protection layer taken in the region where the insulating layer is present.

24. A head arm assembly comprising: a slider including a thin-film magnetic head and disposed to face toward a recording medium; a suspension flexibly supporting the slider; and an arm for making the slider travel across tracks of the recording medium, the suspension being attached to the arm,
the thin-film magnetic head comprising: a medium facing surface that faces toward the recording medium; a magnetoresistive element disposed near the medium facing surface to detect a signal magnetic field sent from the recording medium; and a pair of electrodes for feeding a current for detecting magnetic signals to the magetoresistive element,
the magetoresistive element comprising:
a first magnetic layer;
a second magnetic layer; and
a spacer layer disposed between the first magnetic layer and the second magnetic layer, wherein:
one of the first magnetic layer and the second magnetic layer is a layer whose direction of magnetization is fixed;
the other of the first magnetic layer and the second magnetic layer is a layer whose direction of magnetization changes in response to an external magnetic field;
the spacer layer includes an insulating portion and a conducting portion such that the insulating portion and the conducting portion are both present in a cross section parallel to a plane of the spacer layer; and
in the magnetoresistive element, the current for detecting magnetic signals is fed in a direction intersecting the plane of each layer making up the magnetoresistive element,
the spacer layer including:
a nonmagnetic metal layer made of a nonmagnetic metal material and disposed on the first magnetic layer;
a protection layer disposed on the nonmagnetic metal layer to prevent oxidation or nitriding of the nonmagnetic metal layer; and
an insulating layer disposed on the protection layer and constituting the insulating portion, wherein:
when seen in a direction perpendicular to a top surface of the first magnetic layer, there are formed in the spacer layer a region where the insulating layer is present and a region where the insulating layer is absent;
the conducting portion is located in the region where the insulating layer is absent; and
a thickness of the protection layer taken in at least part of the region where the insulating layer is absent is zero or smaller than a thickness of the protection layer taken in the region where the insulating layer is present.

25. A magnetic disk drive comprising: a slider including a thin-film magnetic head and disposed to face toward a recording medium that is driven to rotate; and an alignment device supporting the slider and aligning the slider with respect to the recording medium,
the thin-film magnetic head comprising: a medium facing surface that faces toward the recording medium; a magnetoresistive element disposed near the medium facing surface to detect a signal magnetic field sent from the recording medium; and a pair of electrodes for feeding a current for detecting magnetic signals to the magetoresistive element,
the magetoresistive element comprising:
a first magnetic layer;
a second magnetic layer; and
a spacer layer disposed between the first magnetic layer and the second magnetic layer, wherein:
one of the first magnetic layer and the second magnetic layer is a layer whose direction of magnetization is fixed;
the other of the first magnetic layer and the second magnetic layer is a layer whose direction of magnetization changes in response to an external magnetic field;
the spacer layer includes an insulating portion and a conducting portion such that the insulating portion and the conducting portion are both present in a cross section parallel to a plane of the spacer layer; and
in the magnetoresistive element, the current for detecting magnetic signals is fed in a direction intersecting the plane of each layer making up the magnetoresistive element,
the spacer layer including:
a nonmagnetic metal layer made of a nonmagnetic metal material and disposed on the first magnetic layer;
a protection layer disposed on the nonmagnetic metal layer to prevent oxidation or nitriding of the nonmagnetic metal layer; and
an insulating layer disposed on the protection layer and constituting the insulating portion, wherein:
when seen in a direction perpendicular to a top surface of the first magnetic layer, there are formed in the spacer layer a region where the insulating layer is present and a region where the insulating layer is absent;
the conducting portion is located in the region where the insulating layer is absent; and
a thickness of the protection layer taken in at least part of the region where the insulating layer is absent is zero or smaller than a thickness of the protection layer taken in the region where the insulating layer is present.
